(19) United States
(12) Patent Application Publication
(10) Pub. No.: US 2022/0415179 A1
(43) Pub. Date: Dec. 29, 2022

(54) SUB-PLATOONS WITHIN VEHICLE-TO-EVERYTHING TECHNOLOGY

(71) Applicant: QUALCOMM Incorporated, San Diego, CA (US)

(72) Inventors: Akash KUMAR, Hyderabad (IN); Amit JAIN, San Diego, CA (US)

(21) Appl. No.: 17/304,635

(22) Filed: Jun. 23, 2021

(51) Int. Cl. G08G 1/00; G05D 1/02; G05D 1/00; H04W 4/46

(52) U.S. Cl. CPC G08G 1/22; G05D 1/0291; G05D 1/0022; H04W 4/46; G05D 2201/0213

(57) ABSTRACT

Various aspects of the present disclosure generally relate to wireless communication. In some aspects, a mobile station may transmit, to a controller, a request to join a platoon. The mobile station may receive, from the controller, a confirmation that the mobile station has joined the platoon. The confirmation may further indicate an assignment of the mobile station to a sub-platoon within the platoon. Accordingly, the mobile station may transmit a handshake to, or receiving a handshake from, a primary anchor device associated with the platoon. The mobile station may additionally transmit a handshake to, or receiving a handshake from, a secondary anchor device associated with the sub-platoon. The sub-platoon may divide and reassemble based at least in part on one or more environmental conditions. Numerous other aspects are described.

### FIELD OF THE DISCLOSURE

Aspects of the present disclosure generally relate to wireless communication and to techniques and apparatuses for assigning and managing sub-platoons within vehicle-to-everything technology.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A UE may communicate with a BS via the downlink and uplink. “Downlink” (or forward link) refers to the communication link from the BS to the UE, and “uplink” (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, or the like.

The above multiple access technologies have been adopted in various telecommunication standards to provide a common protocol that enables different user equipment to communicate on a municipal, national, regional, and even global level. NR, which may also be referred to as 5G, is a set of enhancements to the LTE mobile standard promulgated by the 3GPP. NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a mobile station includes a memory and one or more processors coupled to the memory, the memory and the one or more processors configured to transmit, to a controller, a request to join a platoon; receive, from the controller, a confirmation that the mobile station has joined the platoon, wherein the confirmation further indicates an assignment of the mobile station to a sub-platoon within the platoon; transmit a handshake to, or receive a handshake from, a primary anchor device associated with the platoon; and transmit a handshake to, or receive a handshake from, a secondary anchor device associated with the sub-platoon.

In some aspects, a mobile station includes a memory and one or more processors coupled to the memory, the memory and the one or more processors configured to receive, from a controller, an indication that the mobile station is a secondary anchor device for a sub-platoon within a platoon, wherein the platoon includes a primary anchor device and the mobile station; transmit a handshake to, or receive a handshake from, the primary anchor device associated with the platoon; and transmit one or more handshakes to, or receive one or more handshakes from, one or more additional mobile stations included in the sub-platoon.

In some aspects, a mobile station includes a memory and one or more processors coupled to the memory, the memory and the one or more processors configured to transmit, to an additional mobile station, an indication that the additional mobile station is a secondary anchor device for a sub-platoon within a platoon, wherein the mobile station is a primary anchor device for the platoon; transmit a handshake to, or receive a handshake from, the secondary anchor device associated with the sub-platoon; and transmit one or more handshakes to, or receive one or more handshakes from, one or more other mobile stations included in the platoon.

In some aspects, a control system includes a memory and one or more processors coupled to the memory, the memory and the one or more processors configured to receive, from a mobile station, a request to join a platoon; and transmit, to the mobile station, a confirmation that the mobile station has joined the platoon, wherein the confirmation further indicates an assignment of the mobile station to a sub-platoon within the platoon.

In some aspects, a method of wireless communication performed by a mobile station includes transmitting, to a controller, a request to join a platoon; receiving, from the controller, a confirmation that the mobile station has joined the platoon, wherein the confirmation further indicates an assignment of the mobile station to a sub-platoon within the platoon; transmitting a handshake to, or receiving a handshake from, a primary anchor device associated with the platoon; and transmitting a handshake to, or receiving a handshake from, a secondary anchor device associated with the sub-platoon.

In some aspects, a method of wireless communication performed by a mobile station includes receiving, from a controller, an indication that the mobile station is a secondary anchor device for a sub-platoon within a platoon, wherein the platoon includes a primary anchor device and the mobile station; transmitting a handshake to, or receiving a handshake from, the primary anchor device associated with the platoon; and transmitting one or more handshakes to, or receiving one or more handshakes from, one or more additional mobile stations included in the sub-platoon.

In some aspects, a method of wireless communication performed by a mobile station includes transmitting, to an additional mobile station, an indication that the additional mobile station is a secondary anchor device for a sub-platoon within a platoon, wherein the mobile station is a primary anchor device for the platoon; transmitting a handshake to, or receiving a handshake from, the secondary anchor device associated with the sub-platoon; and transmitting one or more handshakes to, or receiving one or more handshakes from, one or more other mobile stations included in the platoon.

In some aspects, a method of wireless communication performed by a control system includes receiving, from a mobile station, a request to join a platoon; and transmitting, to the mobile station, a confirmation that the mobile station has joined the platoon, wherein the confirmation further indicates an assignment of the mobile station to a sub-platoon within the platoon.

In some aspects, a non-transitory computer-readable medium storing a set of instructions for wireless communication includes one or more instructions that, when executed by one or more processors of a mobile station, cause the mobile station to transmit, to a controller, a request to join a platoon; receive, from the controller, a confirmation that the mobile station has joined the platoon, wherein the confirmation further indicates an assignment of the mobile station to a sub-platoon within the platoon; transmit a handshake to, or receive a handshake from, a primary anchor device associated with the platoon; and transmit a handshake to, or receive a handshake from, a secondary anchor device associated with the sub-platoon.

In some aspects, a non-transitory computer-readable medium storing a set of instructions for wireless communication includes one or more instructions that, when executed by one or more processors of a mobile station, cause the mobile station to receive, from a controller, an indication that the mobile station is a secondary anchor device for a sub-platoon within a platoon, wherein the platoon includes a primary anchor device and the mobile station; transmit a handshake to, or receive a handshake from, the primary anchor device associated with the platoon; and transmit one or more handshakes to, or receive one or more handshakes from, one or more additional mobile stations included in the sub-platoon.

In some aspects, a non-transitory computer-readable medium storing a set of instructions for wireless communication includes one or more instructions that, when executed by one or more processors of a mobile station, cause the mobile station to transmit, to an additional mobile station, an indication that the additional mobile station is a secondary anchor device for a sub-platoon within a platoon, wherein the mobile station is a primary anchor device for the platoon; transmit a handshake to, or receive a handshake from, the secondary anchor device associated with the sub-platoon; and transmit one or more handshakes to, or receive one or more handshakes from, one or more other mobile stations included in the platoon.

In some aspects, a non-transitory computer-readable medium storing a set of instructions for wireless communication includes one or more instructions that, when executed by one or more processors of a control system, cause the control system to receive, from a mobile station, a request to join a platoon; and transmit, to the mobile station, a confirmation that the mobile station has joined the platoon, wherein the confirmation further indicates an assignment of the mobile station to a sub-platoon within the platoon.

In some aspects, an apparatus for wireless communication includes means for transmitting, to a controller, a request to join a platoon; means for receiving, from the controller, a confirmation that the apparatus has joined the platoon, wherein the confirmation further indicates an assignment of the apparatus to a sub-platoon within the platoon; means for transmitting a handshake to, or means for receiving a handshake from, a primary anchor device associated with the platoon; and means for transmitting a handshake to, or means for receiving a handshake from, a secondary anchor device associated with the sub-platoon.

In some aspects, an apparatus for wireless communication includes means for receiving, from a controller, an indication that the apparatus is a secondary anchor device for a sub-platoon within a platoon, wherein the platoon includes a primary anchor device and the apparatus; means for transmitting a handshake to, or means for receiving a handshake from, the primary anchor device associated with the platoon; and means for transmitting one or more handshakes to, or means for receiving one or more handshakes from, one or more mobile stations included in the sub-platoon.

In some aspects, an apparatus for wireless communication includes means for transmitting, to a mobile station, an indication that the mobile station is a secondary anchor device for a sub-platoon within a platoon, wherein the apparatus is a primary anchor device for the platoon; means for transmitting a handshake to, or means for receiving a handshake from, the secondary anchor device associated with the sub-platoon; and means for transmitting one or more handshakes to, or means for receiving one or more handshakes from, one or more other mobile stations included in the platoon.

In some aspects, an apparatus for wireless communication includes means for receiving, from a mobile station, a request to join a platoon; and means for transmitting, to the mobile station, a confirmation that the mobile station has joined the platoon, wherein the confirmation further indicates an assignment of the mobile station to a sub-platoon within the platoon.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, or artificial intelligence-enabled devices). Aspects may be implemented in chip-level components, modular components, non-modular components, non-chip-level components, device-level components, or system-level components. Devices incorporating described aspects and features may include additional components and features for implementation and practice of claimed and described aspects. For example, transmission and reception of wireless signals may include a number of components for analog and digital purposes (e.g., hardware components including antennas, radio frequency (RF) chains, power amplifiers, modulators, buffers, processors, interleavers, adders, or summers). It is intended that aspects described herein may be practiced in a wide variety of devices, components, systems, distributed arrangements, or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of platooning within a vehicle-to-everything (V2X) system, in accordance with the present disclosure.

FIG. 4 is a diagram illustrating an example associated with sub-platooning within a V2X system, in accordance with the present disclosure.

FIGS. 5, 6, and 7 are diagrams illustrating examples associated with dividing and reassembling a sub-platoon, in accordance with the present disclosure.

FIGS. 8, 9, 10, and 11 are diagrams illustrating example processes associated with assigning and managing sub-platoons within V2X technology, in accordance with the present disclosure.

FIGS. 12 and 13 are block diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

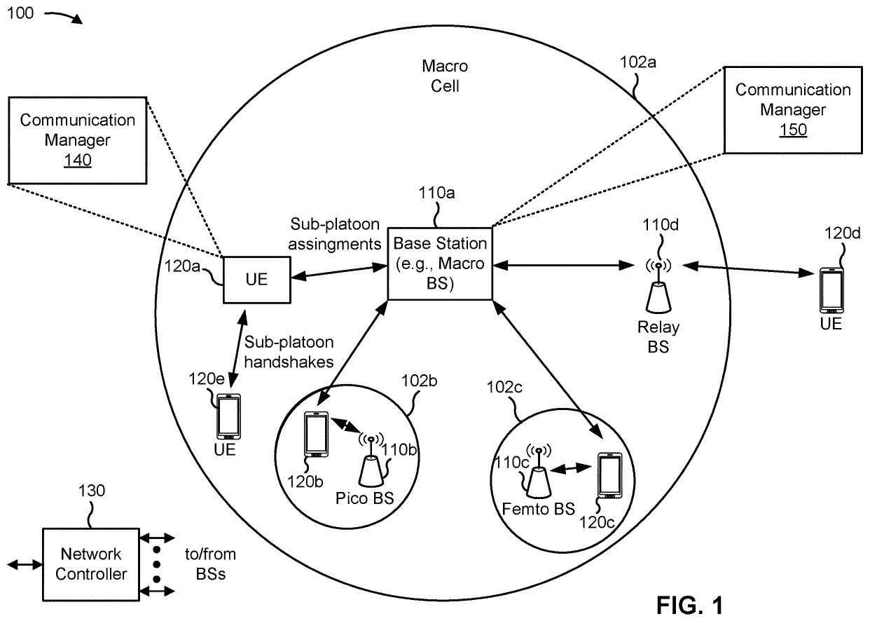

FIG. 1 is a diagram illustrating an example of a wireless network 100, in accordance with the present disclosure. The wireless network 100 may be or may include elements of a 5G (NR) network and/or an LTE network, among other examples. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. ABS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces, such as a direct physical connection or a virtual network, using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, or the like.

Wireless network 100 may be a heterogeneous network that includes BSs of different types, such as macro BSs, pico BSs, femto BSs, relay BSs, or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, and/or location tags, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components and/or memory components. In some aspects, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks may be deployed in a given geographic area. Each wireless network may support a particular RAT and may operate on one or more frequencies. A RAT may also be referred to as a radio technology, an air interface, or the like. A frequency may also be referred to as a carrier, a frequency channel, or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a V2X protocol (e.g., which may include a vehicle-to-vehicle (V2V) protocol or a vehicle-to-infrastructure (V21) protocol), and/or a mesh network. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

In some aspects, a mobile station (e.g., the UE 120a) may include a communication manager 140. As described in more detail elsewhere herein, the communication manager 140 may transmit, to a controller (e.g., another UE, such as the UE 120e and/or the base station 110a), a request to join a platoon; receive, from the controller, a confirmation that the mobile station has joined the platoon, the confirmation further indicating an assignment of the mobile station to a sub-platoon within the platoon; transmit a handshake to, or receive a handshake from, a primary anchor device (e.g., another UE) associated with the platoon; and transmit a handshake to, or receiving a handshake from, a secondary anchor device (e.g., another UE) associated with the sub-platoon. Additionally, or alternatively, the communication manager 140 may perform one or more other operations described herein.

In some aspects, and as described in more detail elsewhere herein, the communication manager 140 may receive, from a controller (e.g., another UE, such as the UE 120e and/or the base station 110a), an indication that the mobile station is a secondary anchor device for a sub-platoon within a platoon, the platoon including a primary anchor device (e.g., another UE) and the mobile station; transmit a handshake to, or receive a handshake from, the primary anchor device associated with the platoon; and transmit one or more handshakes to, or receive one or more handshakes from, one or more additional mobile stations (e.g., one or more additional UEs) included in the sub-platoon. Additionally, or alternatively, the communication manager 140 may perform one or more other operations described herein.

In some aspects, and as described in more detail elsewhere herein, the communication manager 140 may transmit, to an additional mobile station (e.g., another UE, such as the UE 120e), an indication that the additional mobile station is a secondary anchor device for a sub-platoon within a platoon, the mobile station being a primary anchor device for the platoon; transmit a handshake to, or receive a handshake from, the secondary anchor device associated with the sub-platoon; and transmit one or more handshakes to, or receive one or more handshakes from, one or more other mobile stations (e.g., one or more other UEs) included in the platoon. Additionally, or alternatively, the communication manager 140 may perform one or more other operations described herein.

In some aspects, a control system (e.g., the base station 110a) may include a communication manager 150. As described in more detail elsewhere herein, the communication manager 150 may receive, from a mobile station (e.g., the UE 120a), a request to join a platoon; and transmit, to the mobile station, a confirmation that the mobile station has joined the platoon, the confirmation further indicating an assignment of the mobile station to a sub-platoon within the platoon. Additionally, or alternatively, the communication manager 150 may perform one or more other operations described herein.

As indicated above, FIG. 1 is provided as an example. Other examples may differ from what is described with regard to FIG. 1.

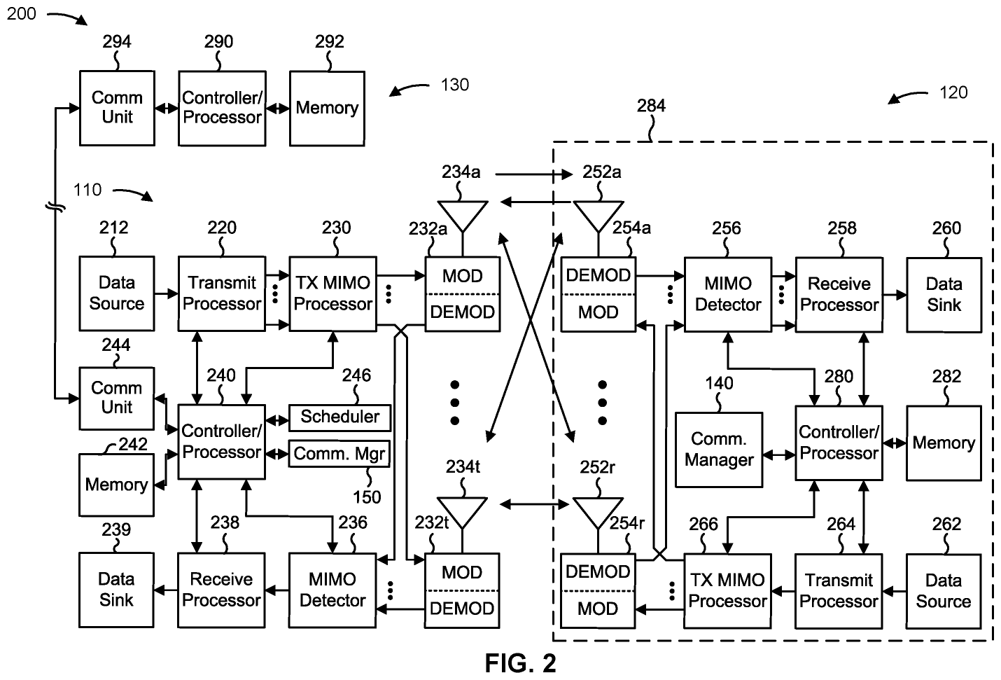

FIG. 2 is a diagram illustrating an example 200 of a base station 110 in communication with a UE 120 in a wireless network 100, in accordance with the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI)) and control information (e.g., CQI requests, grants, and/or upper layer signaling) and provide overhead symbols and control symbols. Transmit processor 220 may also generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

Antennas (e.g., antennas 234a through 234t and/or antennas 252a through 252r) may include, or may be included within, one or more antenna panels, antenna groups, sets of antenna elements, and/or antenna arrays, among other examples. An antenna panel, an antenna group, a set of antenna elements, and/or an antenna array may include one or more antenna elements. An antenna panel, an antenna group, a set of antenna elements, and/or an antenna array may include a set of coplanar antenna elements and/or a set of non-coplanar antenna elements. An antenna panel, an antenna group, a set of antenna elements, and/or an antenna array may include antenna elements within a single housing and/or antenna elements within multiple housings. An antenna panel, an antenna group, a set of antenna elements, and/or an antenna array may include one or more antenna elements coupled to one or more transmission and/or reception components, such as one or more components of FIG. 2.

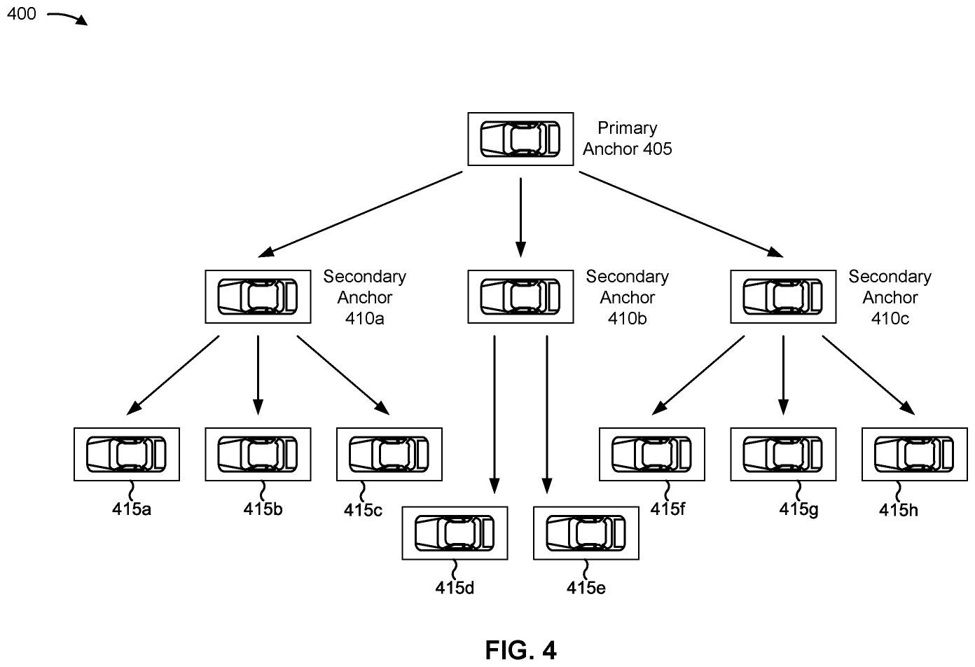

On the uplink, at UE 120, a transmit processor 264 may receive and process data from a data source 262 and control information (e.g., for reports that include RSRP, RSSI, RSRQ, and/or CQI) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM or CP-OFDM), and transmitted to base station 110. In some aspects, a modulator and a demodulator (e.g., MOD/DEMOD 254) of the UE 120 may be included in a modem of the UE 120. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein (for example, with reference to FIGS. 4-11).

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, a modulator and a demodulator (e.g., MOD/DEMOD 232) of the base station 110 may be included in a modem of the base station 110. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein (for example, with reference to FIGS. 4-11).

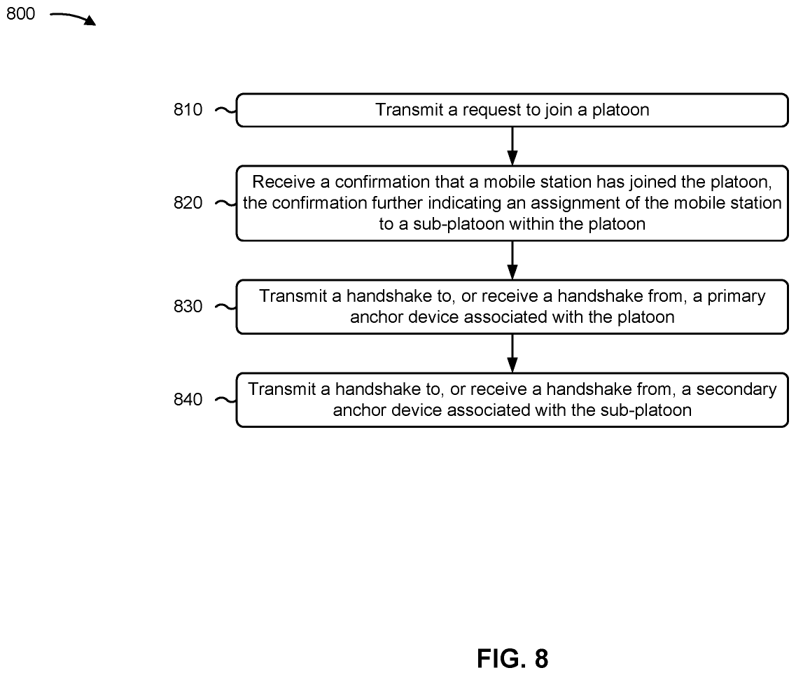

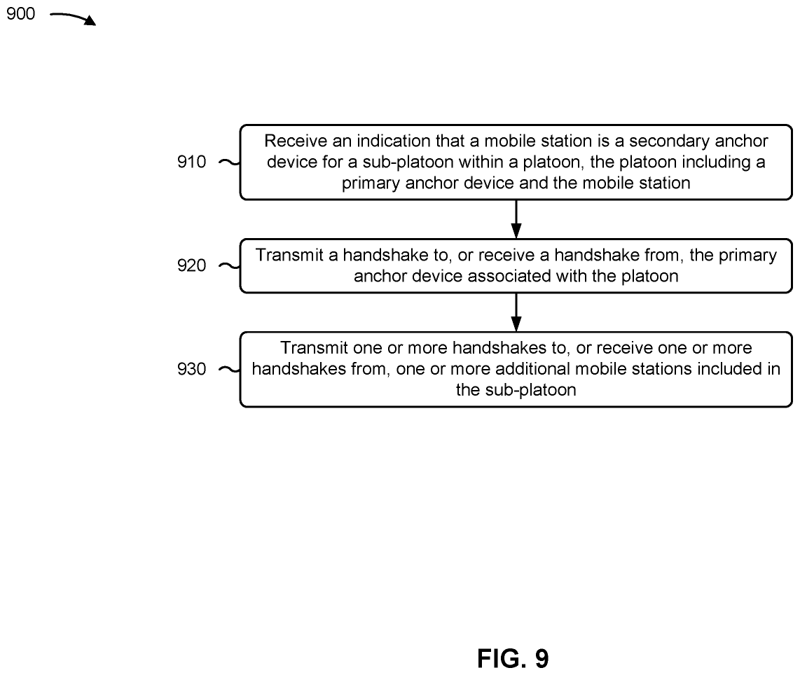

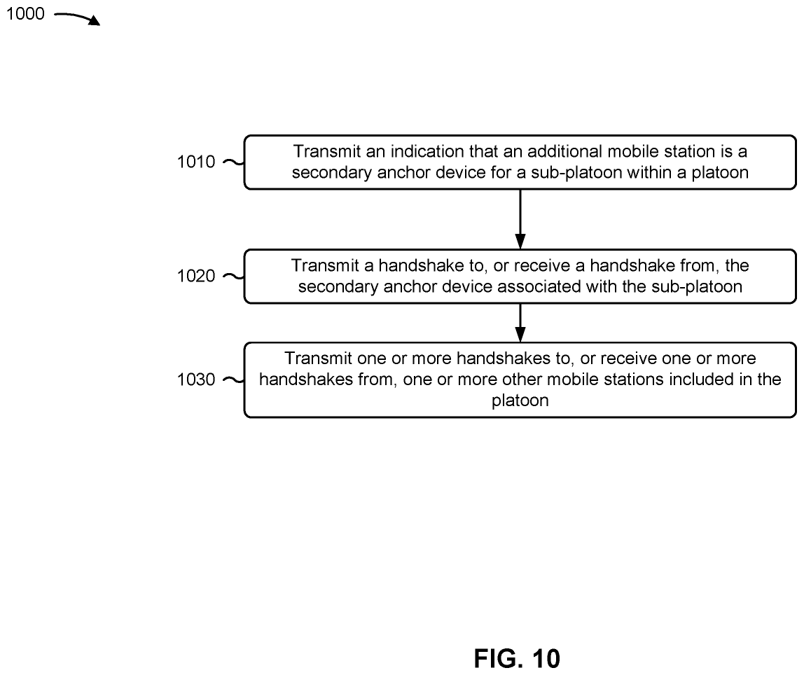

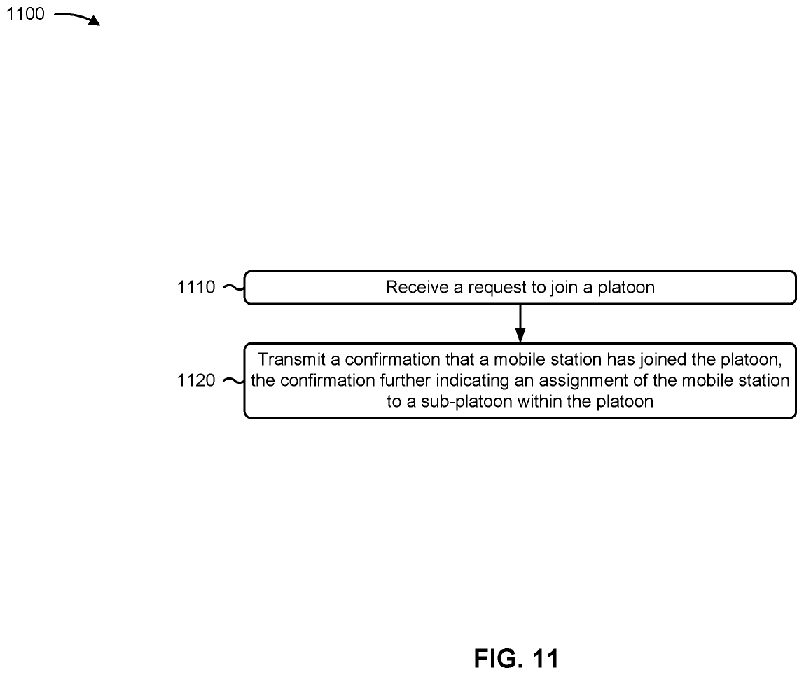

Controller/processor 240 of base station 110, controller/processor 280 of UE 120, and/or any other component(s) of FIG. 2 may perform one or more techniques associated with assigning and managing sub-platoons within V2X technology, as described in more detail elsewhere herein. For example, controller/processor 240 of base station 110, controller/processor 280 of UE 120, and/or any other component(s) of FIG. 2 may perform or direct operations of, for example, process 800 of FIG. 8, process 900 of FIG. 9, process 1000 of FIG. 10, process 1100 of FIG. 11, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, process 1000 of FIG. 10, process 1100 of FIG. 11, and/or other processes as described herein. In some aspects, executing instructions may include running the instructions, converting the instructions, compiling the instructions, and/or interpreting the instructions, among other examples. In some aspects, the mobile station described herein is the UE 120, is included in the UE 120, or includes one or more components of the UE 120 shown in FIG. 2. In some aspects, the control system described herein is the base station 110, is included in the base station 110, or includes one or more components of the base station 110 shown in FIG. 2. Additionally, or alternatively, the control system described herein is included in the core network supporting the base station 110 or is otherwise in communication with mobile stations via the base station 110.

In some aspects, a mobile station (e.g., the UE 120) may include means for transmitting, to a controller, a request to join a platoon; means for receiving, from the controller (e.g., another UE and/or the base station 110), a confirmation that the mobile station has joined the platoon, wherein the confirmation further indicates an assignment of the mobile station to a sub-platoon within the platoon; means for transmitting a handshake to, or receiving a handshake from, a primary anchor device (e.g., another UE) associated with the platoon; and/or means for transmitting a handshake to, or means for receiving a handshake from, a secondary anchor device (e.g., another UE) associated with the sub-platoon. In some aspects, the means for the mobile station to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a mobile station (e.g., the UE 120) may include means for receiving, from a controller (e.g., another UE and/or the base station 110), an indication that the mobile station is a secondary anchor device for a sub-platoon within a platoon, wherein the platoon includes a primary anchor device (e.g., another UE) and the mobile station; means for transmitting a handshake to, or means for receiving a handshake from, the primary anchor device associated with the platoon; and/or means for transmitting one or more handshakes to, or means for receiving one or more handshakes from, one or more additional mobile stations (e.g., one or more additional UEs) included in the sub-platoon. In some aspects, the means for the mobile station to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a mobile station (e.g., the UE 120) may include means for transmitting, to an additional mobile station (e.g., another UE), an indication that the additional mobile station is a secondary anchor device for a sub-platoon within a platoon, wherein the mobile station is a primary anchor device for the platoon; means for transmitting a handshake to, or means for receiving a handshake from, the secondary anchor device associated with the sub-platoon; and/or means for transmitting one or more handshakes to, or means for receiving one or more handshakes from, one or more other mobile stations (e.g., one or more other UEs) included in the platoon. In some aspects, the means for the mobile station to perform operations described herein may include, for example, one or more of communication manager 140, antenna 252, demodulator 254, MIMO detector 256, receive processor 258, transmit processor 264, TX MIMO processor 266, modulator 254, controller/processor 280, or memory 282.

In some aspects, a control system (e.g., the base station 110) may include means for receiving, from a mobile station (e.g., the UE 120), a request to join a platoon; and/or means for transmitting, to the mobile station, a confirmation that the mobile station has joined the platoon, wherein the confirmation further indicates an assignment of the mobile station to a sub-platoon within the platoon. In some aspects, the means for the control system to perform operations described herein may include, for example, one or more of communication manager 150, transmit processor 220, TX MIMO processor 230, modulator 232, antenna 234, demodulator 232, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

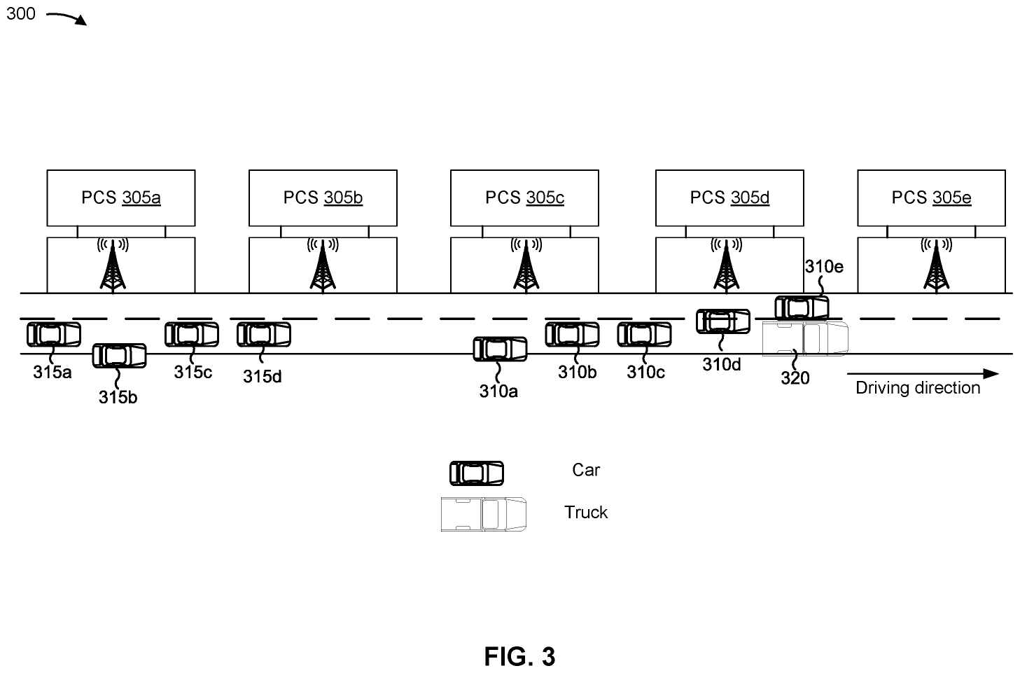

FIG. 3 is a diagram illustrating an example 300 of platooning within a V2X system, in accordance with the present disclosure. In example 300, a V2X system may include one or more control systems (e.g., platooning control systems (PCSs) 305a, 305b, 305c, 305d, and 305e in example 300) in communication (e.g., over-the-air (OTA) via one or more wireless networks, such as wireless network 100 of FIG. 1) with one or more mobile stations. In some aspects, the PCSs 305a, 305b, 305c, 305d, and/or 305e may be included in one or more base stations (e.g., base station 110a of FIG. 1) and/or may include one or more components of a base station. As an alternative, the PCSs 305a, 305b, 305c, 305d, and/or 305e may be included in a core network supporting one or more base stations (e.g., base station 110a of FIG. 1) or may otherwise be in communication with the base station(s).

In some aspects, the mobile stations may include, or be included in, one or more vehicles (e.g., cars 310a, 310b, 310c, 310d, and/or 310e; cars 315a, 315b, 315c, and/or 315d; and/or truck 320 in example 300). For example, the vehicle(s) may be autonomous or semi-autonomous. The mobile stations may be in communication (e.g., OTA via one or more wireless networks, such as wireless network 100 of FIG. 1) with each other in additional to the PCSs 305a, 305b, 305c, 305d, and/or 305e. For example, the mobile stations and the PCSs 305a, 305b, 305c, 305d, and/or 305e may communicate according to V2X standards, such as the Institute of Electrical and Electronics Engineers (IEEE) Local Area Network/Metropolitan Area Network (LAN/MAN) Standards Committee's 802.11p standards (also referred to as “IEEE 802.11p protocols,” “dedicated short-range communications” or “DSRC,” and/or “wireless access in vehicular environments” or “WAVE”). Additionally, or alternatively, the mobile stations and the PCSs 305a, 305b, 305c, 305d, and/or 305e may communicate according to cellular V2X (C-V2X) standards, such as those set forth in 3GPP specifications.

In some aspects, a plurality of mobile stations may form a platoon. In example 300, cars 310a, 310b, 310c, 310d, and 310e have formed a platoon. Cars 315a, 315b, 315c, and 315d may form a separate platoon and/or may operate as individual vehicles (e.g., that are autonomous, semi-autonomous, or manual). Although described in connection with cars, the description similarly applies to other classes of vehicles (e.g., trucks, such as truck 320).

In the platoon, one vehicle may serve as an anchor vehicle for the platoon. For example, a lead vehicle (e.g., car 310e in example 300) may serve as the anchor vehicle. As an alternative, another vehicle within the platoon may serve as the anchor vehicle. By forming a platoon, the cars 310a, 310b, 310c, 310d, and 310e may experience better fuel (e.g., gas and/or electricity) efficiency and may conserve processing resources and power by using the anchor vehicle to navigate the entire platoon (e.g., as described below).

In some aspects, one or more of the PCSs 305a, 305b, 305c, 305d, and/or 305e may transmit an indication to the mobile station associated with the car 310e that the mobile station is the anchor for the platoon. Accordingly, the PCSs 305a, 305b, 305c, 305d, and/or 305e and/or the mobile station associated with the car 310e may transmit indications of the car 310e being the anchor vehicle to the mobile stations associated with the cars 310a, 310b, 310c, and/or 310d. As an alternative, the mobile stations associated with the cars 310a, 310b, 310c, 310d, and/or 310e may autonomously select the mobile station associated with the car 310e as the anchor for the platoon. For example, the mobile stations associated with the cars 310a, 310b, 310c, 310d, and/or 310e may exchange one or more messages that indicate selection of the mobile station associated with the car 310e as the anchor. In some aspects, the mobile stations associated with the cars 310a, 310b, 310c, 310d, and/or 310e may autonomously select the anchor based at least in part on which mobile station is associated with the lead vehicle (e.g., car 310e in example 300).

In order to maintain the platoon, the mobile stations associated with the cars 310a, 310b, 310c, and/or 310d may exchange handshakes with the mobile station associated with the car 310e, which is the anchor for the platoon. The handshakes may be periodic. For example, the mobile stations associated with the cars 310a, 310b, 310c, and/or 310d may be configured to transmit messages to the mobile station associated with the car 310e every 10 milliseconds (ms), every 50 ms, every 500 ms, every 1 second, or so on. Additionally, or alternatively, the mobile station associated with the car 310e may be configured to transmit requests and/or navigation updates to the mobile stations associated with the cars 310a, 310b, 310c, and/or 310d every 10 ms, every 50 ms, every 500 ms, every 1 second, or so on. The messages from the mobile stations associated with the cars 310a, 310b, 310c, and/or 310d may indicate locations and/or velocities associated with the cars 310a, 310b, 310c, and/or 310d, respectively. Accordingly, the mobile station associated with the car 310e may determine navigation instructions (e.g., as described below) based at least in part on the messages from the mobile stations associated with the cars 310a, 310b, 310c, and/or 310d. Thus, the requests from the mobile station associated with the car 310e may include requests for locations and/or velocities associated with the cars 310a, 310b, 310c, and/or 310d. Additionally, or alternatively, the navigation updates from the mobile station associated with the car 310e may include indications of how the platoon will travel. For example, the indications may include high-level indications of navigational maneuvers (e.g., keep true, turn left, veer right, change lanes, take an off-ramp, merge into traffic, stop, speed up, and so on) and/or detailed indications regarding movement of the platoon (e.g., a desired speed of the platoon, a desired heading of the platoon, and so on).

Additionally, or alternatively, the handshakes may be on-demand. For example, the mobile station associated with the car 310e may determine to transmit requests and/or navigational updates more frequently than a configured period when undergoing some maneuvers (e.g., lane changes, stopping, merging, and so on). Additionally, or alternatively, the mobile stations associated with the cars 310a, 310b, 310c, and/or 310d may determine to transmit messages more frequently than a configured period based at least in part on environmental conditions (e.g., detecting compression of the platoon, such as during a stop, detecting turning of the platoon, and so on).

In order to navigate the platoon, the anchor, which is the mobile station associated with the car 310e in example 300, may use one or more sensors (e.g., visual cameras, infrared cameras, light detection and ranging (LIDAR), radio detection and ranging (RADAR), and so on) to determine navigational maneuvers for the platoon based at least in part on environmental conditions (e.g., other vehicles not included in the platoon, emergency situations, traffic signals, and so on). The other mobile stations in the platoon (e.g., the mobile stations associated with the cars 310a, 310b, 310c, and/or 310d) may use one or more sensors to sense distances between mobile stations in the platoon (e.g., such that collisions do not occur within the platoon), but can reduce power and processing resources consumed by the sensor(s) because the anchor is determining navigational maneuvers for the platoon.

The fuel efficiency, power savings, and conservation of processing resources increases with a size of a platoon. However, large platoons may waste fuel and power in emergencies, at traffic signals (e.g., traffic lights), while allowing other vehicles to change lanes, and other circumstances. For example, large platoons may try to slow down when an anchor vehicle for the platoon detects an emergency, but this causes a shockwave effect such that vehicles closer to an end of the platoon slow down significantly or even come to a complete stop, which wastes fuel and power. In another example, in order to allow other vehicles to change lanes, large platoons may try to slow down, but this also causes the shockwave effect described above. Similarly, at traffic signals, large platoons may stop rather than proceeding through the traffic signal (e.g., proceeding through an intersection associated with the traffic signal) when the platoon is too large to proceed through the traffic signal before the signal changes, but this also wastes fuel and power.

Accordingly, platoons may divide in these circumstances. However, when a platoon divides, all vehicles within the platoon are independently autonomous or semi-autonomous, which consumes a significant amount of power and processing resources. Additionally, reassembling the platoon after the emergency, traffic signal, lane change, and other circumstance has passed, consumes significant network overhead since each vehicle must independently rejoin the platoon.

Some techniques and apparatuses described herein enable assignment of mobile stations to one out of a plurality of sub-platoons within a platoon. Accordingly, large platoons may be formed in order to increase fuel efficiency, power savings, and conservation of processing resources. However, the platoon may also divide into sub-platoons with little network overhead in emergencies, at traffic signals, while allowing other vehicles to change lanes, and other circumstances. As a result, the sub-platoons may conserve fuel and power as compared with the platoon being maintained. For example, some sub-platoons may change lanes in response to an emergency or a lane change request, such that the shockwave effect does not waste fuel and power. Similarly, some sub-platoons may proceed through a traffic signal while other sub-platoons stop at the traffic signal, such that the platoon does not waste fuel and power by stopping all vehicles in the platoon at the traffic signal. Additionally, the sub-platoons may reassemble the platoon after the emergency, traffic signal, lane change, and other circumstance has passed with much less network overhead as compared with each vehicle independently rejoining the platoon.

As indicated above, FIG. 3 is provided as an example. Other examples may differ from what is described with respect to FIG. 3.

FIG. 4 is a diagram illustrating an example 400 associated with sub-platooning within a V2X system, in accordance with the present disclosure. As shown in FIG. 4, example 400 includes a platoon with a primary anchor device 405 (e.g., a mobile station associated with a lead vehicle), a plurality of secondary anchor devices 410a, 410b, and 410c (e.g., additional mobile stations associated with additional vehicles in the platoon), and a plurality of other devices 415a, 415b, 415c, 415d, 415e, 415f, 415g, and 415h (e.g., additional mobile stations associated with additional vehicles in the platoon).

In some aspects, the platoon of example 400 may be formed using a control system (e.g., a PCS as described above in connection with FIG. 3). For example, the control system may transmit, and the device 405 may receive, an indication that the device is the primary anchor device for the platoon. In some aspects, the control system may determine that the device 405 should serve as the primary anchor device based at least in part on the device 405 being associated with a lead vehicle, the device 405 having more sensors and/or battery power than other devices in the platoon, and/or other factors. Additionally, or alternatively, the control system may transmit, and the devices 410a, 410b, and 410c may receive, indications that the devices are the secondary anchor devices for respective sub-platoons within the platoon. In some aspects, the control system may determine that the devices 410a, 410b, and 410c should serve as the secondary anchor devices based at least in part on locations of the devices 410a, 410b, and 410c (e.g., evenly distributed throughout the platoon), the devices 410a, 410b, and 410c having more sensors and/or battery power than other devices in the platoon, and/or other factors.

As an alternative, the platoon of example 400 may be formed autonomously. For example, the device 405 may determine to form the platoon (e.g., independently or in coordination with one or more of devices 410a, 410b, 410c, 415a, 415b, 415c, 415d, 415e, 415f, 415g, and/or 415h). The device 405 may be assigned as the primary anchor device (e.g., independently or in coordination with one or more of devices 410a, 410b, 410c, 415a, 415b, 415c, 415d, 415e, 415f, 415g, and/or 415h). Accordingly, the primary anchor device 405 may transmit, and the devices 410a, 410b, and 410c may receive, indications that the devices are the secondary anchor devices for respective sub-platoons within the platoon.

In any of the aspects described above, the primary anchor device 405 may transmit a handshake to and/or receive a handshake from the secondary anchor devices 410a, 410b, and 410c. The primary anchor device 405 may further transmit a handshake to and/or receive a handshake from the devices 415a, 415b, 415c, 415d, 415e, 415f, 415g, and/or 415h.

Additionally, the secondary anchor device 410a may transmit a handshake to and/or receive a handshake from the devices 415a, 415b, and 415c included in the sub-platoon to which the secondary anchor device 410a is assigned. Similarly, the secondary anchor device 410b may transmit a handshake to and/or receive a handshake from the devices 415d and 415e included in the sub-platoon to which the secondary anchor device 410b is assigned. Similarly, the secondary anchor device 410c may transmit a handshake to and/or receive a handshake from the devices 415f, 415g, and 415h included in the sub-platoon to which the secondary anchor device 410b is assigned.

To join the platoon, any of the devices may transmit, and the PCS and/or the primary anchor device 405 may receive, a request to join a platoon. When the PCS and/or the primary anchor device 405 determine to accept a requesting device into the platoon (e.g., based at least in part on a location and/or a velocity associated with the requesting device), the PCS and/or the primary anchor device 405 may transmit, and the requesting device may receive, a confirmation that a mobile station associated with the requesting device has joined the platoon. The confirmation further indicates an assignment of the mobile station to a sub-platoon within the platoon. For example, devices 415a, 415b, and 415c in example 400 received confirmations that indicated an assignment to the sub-platoon associated with the secondary anchor device 410a. Similarly, devices 415d and 415e in example 400 received confirmations that indicated an assignment to the sub-platoon associated with the secondary anchor device 410b, and devices 415f, 415g, and 415h in example 400 received confirmations that indicated an assignment to the sub-platoon associated with the secondary anchor device 410c. The PCS and/or the primary anchor device 405 may assign the sub-platoon based at least in part on a location and/or a velocity associated with the requesting device. In aspects including a PCS, the PCS may further indicate that the requesting device has joined the platoon to the primary anchor device 405 and to a respective secondary anchor device for the sub-platoon to which the requesting device was assigned. Additionally, or alternatively, the primary anchor device 405 may indicate that the requesting device has joined the platoon to a respective secondary anchor device for the sub-platoon to which the requesting device was assigned.

In some situations, a government, such as a state (e.g., the United States, India, and so on), a subdivision of a state (e.g., a U.S. state, an Indian state, and so on), or a smaller governmental entity (e.g., a city, a town, a village, and so on) and/or an administrative agency (e.g., a national agency, an international agency, and so on) may impose platoon limits on particular roads and/or geographic regions. Additionally, or alternatively, a V2X system may temporarily impose platoon limits in response to an emergency, poor radio quality, or another situation that increases danger for large platoons.

Accordingly, the PCS and/or the primary anchor device 405 may determine a maximum platoon size. For example, the PCS and/or the primary anchor device 405 may receive a broadcast signal (e.g., from a government and/or administrative agency and/or from a V2X system) indicating the maximum platoon size. In another example, the primary anchor device 405 may detect (e.g., using an optical camera) a sign indicating the maximum platoon size. Accordingly, the PCS may transmit, and the primary anchor device 405 may receive, an indication of the maximum platoon size and/or an indication that the platoon is dividing based at least in part on the maximum platoon size. Additionally, or alternatively, the primary anchor device 405 may transmit, and the secondary anchor devices (devices 410a, 410b, and 410c in example 400) may receive, an indication of the maximum platoon size and/or an indication that the platoon is dividing based at least in part on the maximum platoon size. Furthermore, each secondary anchor device may transmit, and devices included in each respective sub-platoons (e.g., devices 415a, 415b, and 415c for secondary anchor device 410a, devices 415d and 415d for secondary anchor device 410b, and devices 415f, 415g, and 415h for secondary anchor device 410c) may receive, an indication that the platoon is dividing.

As an alternative, the PCS and/or the primary anchor device 405 may determine to divide the platoon based at least in part on a geographic zone. For example, the PCS and/or the primary anchor device 405 may receive a broadcast signal (e.g., from a government and/or administrative agency and/or from a V2X system) indicating that a geographic zone is accident-prone or otherwise dangerous. In another example, the primary anchor device 405 may detect (e.g., using an optical camera) a sign indicating that the geographic zone is accident-prone or otherwise dangerous. In another example, the primary anchor device 405 may map a current location of the primary anchor device 405 (e.g., a global position system (GPS) location) to an indicator that the geographic zone is accident-prone or otherwise dangerous (e.g., using a database of maps). Accordingly, the PCS and/or the primary anchor device 405 may determine the maximum platoon size based at least in part on the geographic zone. For example, the PCS and/or the primary anchor device 405 may map an indicator that the geographic zone is accident-prone, a score associated with a dangerousness of the geographic zone, and/or another similar measure to the maximum platoon size (e.g., using a database of values).

Additionally, or alternatively, the PCS and/or the primary anchor device 405 may determine to divide the platoon based at least in part on crowdsourced information. For example, the PCS may receive, from multiple vehicles, indications of accidents and/or accident-prone conditions (e.g., g forces, accelerations, decelerations, and/or other movements associated with accident risk) and determine, based at least in part on the indications, that a geographic zone is accident-prone or otherwise dangerous. Additionally, or alternatively, the primary anchor device 405 may receive (e.g., from the PCS and/or a remote server) an indication that the geographic zone is accident-prone or otherwise dangerous (e.g., based at least in part on crowdsource indications, as described above). Accordingly, the PCS and/or the primary anchor device 405 may determine the maximum platoon size based at least in part on the crowdsourced information. For example, the PCS and/or the primary anchor device 405 may map an indicator that the geographic zone is accident-prone, a score associated with a dangerousness of the geographic zone, and/or another similar measure to the maximum platoon size (e.g., using a database of values).

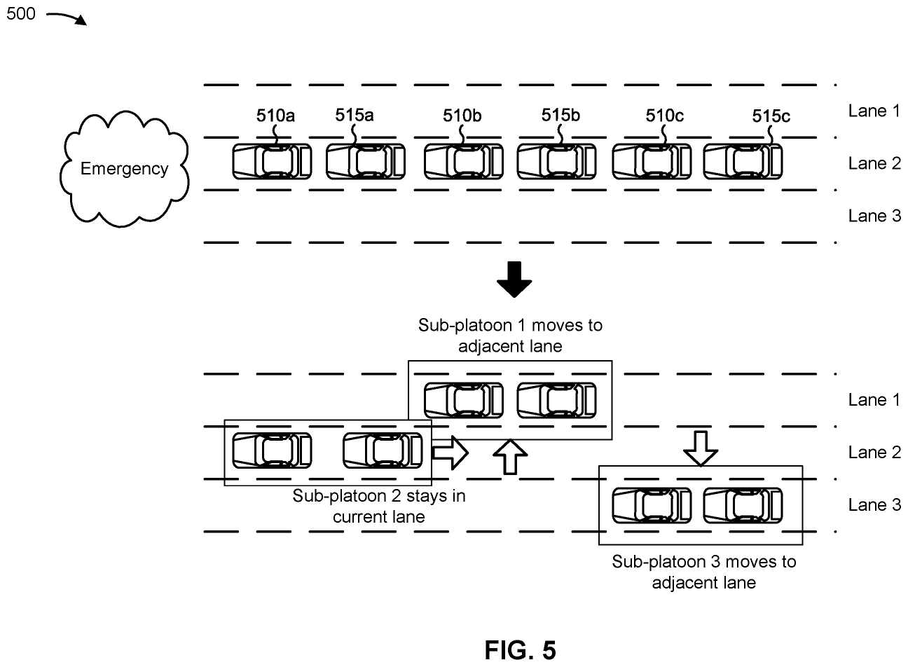

Accordingly, each secondary anchor device may become a primary anchor device (e.g., as described above in connection with FIG. 3) for each respective sub-platoon. Although depicted separately in FIG. 4, the primary anchor device 405 may also be a secondary anchor device for one of the sub-platoons within the platoon (e.g., as described below in examples 500, 600, and 700 of FIGS. 5, 6, and 7, respectively). Additionally, the primary anchor device 405 may refrain from handshaking with the secondary anchor devices 410a, 410b, and 410c and/or refrain from handshaking with the devices 415a, 415b, 415c, 415d, 415e, 415f, 415g, and/or 415h, based at least in part on the platoon being divided.

The PCS and/or the primary anchor device 405 may further determine a revised maximum platoon size. For example, the PCS and/or the primary anchor device 405 may stop receiving the broadcast signal that indicated the maximum platoon size (e.g., indicating that there is no maximum in a new geographic area and/or that the maximum was temporary and is lifted) or may receive a new broadcast signal (e.g., from a government and/or administrative agency and/or from a V2X system) indicating the revised maximum platoon size. In another example, the primary anchor device 405 may detect (e.g., using an optical camera) a sign indicating the revised maximum platoon size. Accordingly, the PCS may transmit, and the primary anchor device 405 may receive, an indication of the revised maximum platoon size and/or an indication that the platoon is reassembling based at least in part on the revised maximum platoon size. Additionally, or alternatively, the primary anchor device 405 may transmit, and the secondary anchor devices (devices 410a, 410b, and 410c in example 400) may receive, an indication of the revised maximum platoon size and/or an indication that the platoon is reassembling based at least in part on the maximum platoon size. Furthermore, each secondary anchor device may transmit, and devices included in each respective sub-platoons (e.g., devices 415a, 415b, and 415c for secondary anchor device 410a, devices 415d and 415d for secondary anchor device 410b, and devices 415f, 415g, and 415h for secondary anchor device 410c) may receive, an indication that the platoon is reassembling.

Accordingly, each secondary anchor device may again become a secondary anchor device (e.g., as described above in connection with FIG. 3) for each respective sub-platoon, and the device 405 may again become the primary anchor device for the reassembled platoon. Additionally, the primary anchor device 405 may resume handshaking with the secondary anchor devices 410a, 410b, and 410c and/or resume from handshaking with the devices 415a, 415b, 415c, 415d, 415e, 415f, 415g, and/or 415h, based at least in part on the platoon being divided. Accordingly, by using sub-platooning, the V2X system of example 400 may conserve network overhead and processing resources when dividing the platoon and reassembling the platoon.

To leave the platoon, any of the devices may transmit, and the PCS and/or the primary anchor device 405 may receive, a request to leave a platoon. When the PCS and/or the primary anchor device 405 determine to allow a requesting device to leave the platoon (e.g., based at least in part on a location and/or a velocity associated with the requesting device), the PCS and/or the primary anchor device 405 may transmit, and the requesting device may receive, a confirmation that a mobile station associated with the requesting device is no longer in the platoon. The confirmation further indicates that the mobile station is no longer in a corresponding sub-platoon of the platoon. For example, device 415a, 415b, or 415c in example 400 would receive a confirmation that indicated the requesting device was no longer in the sub-platoon associated with the secondary anchor device 410a. Similarly, device 415d or 415e in example 400 would receive a confirmation that indicated the requesting device was no longer in the sub-platoon associated with the secondary anchor device 410b, and device 415f, 415g, or 415h in example 400 would receive a confirmation that indicated the requesting device was no longer in the sub-platoon associated with the secondary anchor device 410c. In aspects including a PCS, the PCS may further indicate that the requesting device is no longer in the platoon to the primary anchor device 405 and to a respective secondary anchor device for the sub-platoon in which the requesting device was previously. Additionally, or alternatively, the primary anchor device 405 may indicate that the requesting device is no longer in the platoon to a respective secondary anchor device for the sub-platoon in which the requesting device was previously.

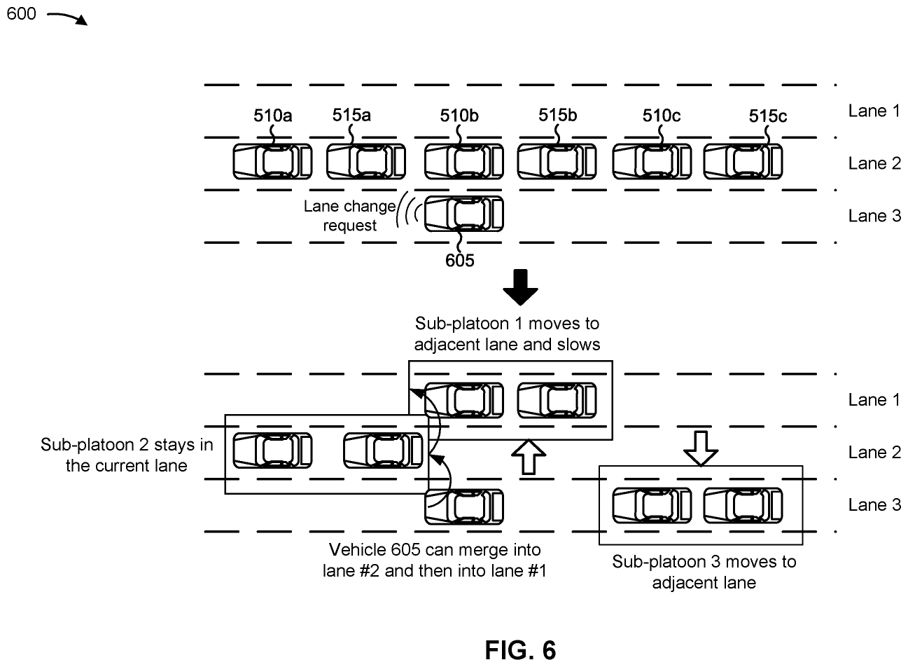

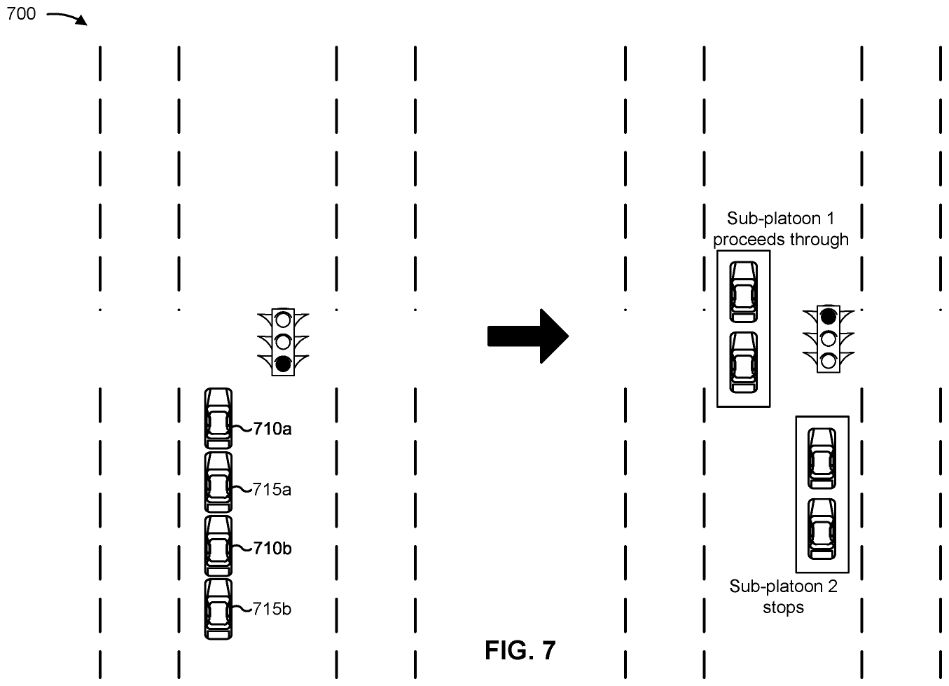

By using techniques as described in connection with FIG. 4, large platoons may be formed in order to increase fuel efficiency, power savings, and conservation of processing resources. However, the platoon may also divide into sub-platoons with little network overhead in emergencies (e.g., as described below in connection with FIG. 5), at traffic signals (e.g., as described below in connection with FIG. 7), while allowing other vehicles to change lanes (e.g., as described below in connection with FIG. 6), and other circumstances. As a result, the sub-platoons may conserve fuel and power as compared with the platoon being maintained. Additionally, the sub-platoons may reassemble the platoon after the emergency, traffic signal, lane change, and other circumstance has passed with much less network overhead as compared with each vehicle independently rejoining the platoon.

As indicated above, FIG. 4 is provided as an example. Other examples may differ from what is described with respect to FIG. 4.

FIG. 5 is a diagram illustrating an example 500 associated with sub-platooning within a V2X system, in accordance with the present disclosure. In example 500, mobile stations associated with vehicles 510a, 515a, 510b, 515b, 510c, and 515c may be included in a platoon. Additionally, the mobile station associated with vehicle 510a may serve as a primary anchor device for the platoon as well as a secondary anchor device for a sub-platoon that also includes the mobile station associated with vehicle 515a. Similarly, the mobile station associated with vehicle 510b may serve as a secondary anchor device for a sub-platoon that also includes the mobile station associated with vehicle 515b, and the mobile station associated with vehicle 510c may serve as a secondary anchor device for a sub-platoon that also includes the mobile station associated with vehicle 515c. The platoon and sub-platoons of example 500 may be formed as described above in connection with FIG. 4.

As shown in FIG. 5, the primary anchor device associated with vehicle 510a may detect an emergency using one or more sensors (e.g., an optical camera, an infrared camera, a LIDAR, a RADAR, and/or another sensor). For example, the primary anchor device associated with vehicle 510a may detect a stopped vehicle ahead, an accident ahead, and/or another emergency. Accordingly, the primary anchor device associated with vehicle 510a may transmit, and the secondary anchor devices associated with vehicles 510b and 510c may receive, an indication of the emergency. Additionally, or alternatively, the primary anchor device associated with vehicle 510a may transmit, and a PCS may receive, the indication of the emergency, such that the PCS may transmit, and the secondary anchor devices associated with vehicles 510b and 510c may receive, an indication that the platoon is dividing (e.g., as described above in connection with FIG. 4) based at least in part on the indication of the emergency indication.

Accordingly, the secondary anchor devices associated with vehicles 510a, 510b, and 510c may determine respective navigation instructions, based at least in part on the indication of the emergency, in coordination with each other. In example 500, the secondary anchor device associated with vehicle 510a has determined to slow down, the secondary anchor device associated with vehicle 510b has determined to move to lane 1, and the secondary anchor device associated with vehicle 510c has determined to move to lane 3. Accordingly, the secondary anchor device associated with vehicle 510a may determine to slow down and transmit an indication of that determination to the secondary anchor devices associated with vehicles 510b and 510c, such that the secondary anchor devices associated with vehicles 510b and 510c determine other navigation instructions. In another example, the secondary anchor device associated with vehicle 510b may detect that lane 1 is available, determine to move to lane 1, and transmit an indication of that determination to the secondary anchor devices associated with vehicles 510a and 510c, such that the secondary anchor devices associated with vehicles 510a and 510c determine other navigation instructions. In yet another example, the secondary anchor device associated with vehicle 510c may detect that lane 3 is available, determine to move to lane 3, and transmit an indication of that determination to the secondary anchor devices associated with vehicles 510a and 510b, such that the secondary anchor devices associated with vehicles 510a and 510b determine other navigation instructions.

Each secondary anchor device may transmit, and devices included in the respective sub-platoon may receive, the respective navigation instruction. As shown in FIG. 5, the navigation instruction may include application of brakes and/or movement into a lane that does not include additional sub platoons. Accordingly, in example 500, the secondary anchor device associated with vehicle 510a may instruct the vehicle 510a based at least in part on a determined navigation instruction as well as transmit the navigation instruction to the device associated with vehicle 515a, which may instruct the vehicle 515a based at least in part on the navigation instruction. Similarly, the secondary anchor device associated with vehicle 510b may instruct the vehicle 510b based at least in part on a determined navigation instruction as well as transmit the navigation instruction to the device associated with vehicle 515b, which may instruct the vehicle 515b based at least in part on the navigation instruction. Similarly, the secondary anchor device associated with vehicle 510c may instruct the vehicle 510c based at least in part on a determined navigation instruction as well as transmit the navigation instruction to the device associated with vehicle 515c, which may instruct the vehicle 515c based at least in part on the navigation instruction.

In some aspects, the platoon may reassemble (e.g., as described above in connection with FIG. 4) after all vehicles in the platoon have proceeded past the emergency. For example, the primary anchor device associated with vehicle 510a may transmit, and the secondary anchor devices associated with vehicles 510b and 510c may receive, an indication that the platoon is reassembling. Additionally, or alternatively, the primary anchor device associated with vehicle 510a may transmit, and a PCS may receive, an indication that all vehicles have proceeded past the emergency, such that the PCS may transmit, and the secondary anchor devices associated with vehicles 510b and 510c may receive, an indication that the platoon is reassembling based at least in part on the indication that all vehicles have proceeded past the emergency.

By using techniques as described in connection with FIG. 5, some sub-platoons may change lanes in response to an emergency. As a result, the platoon does not trigger a shockwave effect, which wastes fuel and power. Additionally, the sub-platoons may reassemble the platoon after the emergency has passed with much less network overhead as compared with each vehicle independently rejoining the platoon.

As indicated above, FIG. 5 is provided as an example. Other examples may differ from what is described with respect to FIG. 5.

FIG. 6 is a diagram illustrating an example 600 associated with sub-platooning within a V2X system, in accordance with the present disclosure. In example 600, mobile stations associated with vehicles 510a, 515a, 510b, 515b, 510c, and 515c may be included in a platoon. Additionally, the mobile station associated with vehicle 510a may serve as a primary anchor device for the platoon as well as a secondary anchor device for a sub-platoon that also includes the mobile station associated with vehicle 515a. Similarly, the mobile station associated with vehicle 510b may serve as a secondary anchor device for a sub-platoon that also includes the mobile station associated with vehicle 515b, and the mobile station associated with vehicle 510c may serve as a secondary anchor device for a sub-platoon that also includes the mobile station associated with vehicle 515c. The platoon and sub-platoons of example 600 may be formed as described above in connection with FIG. 4.

As shown in FIG. 6, the primary anchor device associated with vehicle 510a may receive a lane change request (e.g., from a requesting vehicle 605). In example 600, the requesting vehicle 605 indicates a desire to move to lane 1. Accordingly, the primary anchor device associated with vehicle 510a may transmit, and the secondary anchor devices associated with vehicles 510b and 510c may receive, an indication of the lane change request. Additionally, or alternatively, the primary anchor device associated with vehicle 510a may transmit, and a PCS may receive, the indication of the lane change request, such that the PCS may transmit, and the secondary anchor devices associated with vehicles 510b and 510c may receive, an indication that the platoon is dividing (e.g., as described above in connection with FIG. 4) based at least in part on the indication of the lane change request. In any of the aspects described above, the indication of the lane change request may be further based at least in part on the requesting vehicle 605 being an emergency vehicle. For example, the vehicle 605 may indicate that the vehicle 605 is a fire truck, an ambulance, or another emergency vehicle in the lane change request.

Accordingly, the secondary anchor devices associated with vehicles 510a, 510b, and 510c may determine respective navigation instructions, based at least in part on the indication of the lane change request, in coordination with each other. In example 500, the secondary anchor device associated with vehicle 510a has determined to maintain course, the secondary anchor device associated with vehicle 510b has determined to move to lane 1 and slow down, and the secondary anchor device associated with vehicle 510c has determined to move to lane 3. Accordingly, the secondary anchor device associated with vehicle 510a may determine to maintain course and transmit an indication of that determination to the secondary anchor devices associated with vehicles 510b and 510c, such that the secondary anchor devices associated with vehicles 510b and 510c determine other navigation instructions. In another example, the secondary anchor device associated with vehicle 510b may detect that lane 1 is available, determine to move to lane 1 and slow down, and transmit an indication of that determination to the secondary anchor devices associated with vehicles 510a and 510c, such that the secondary anchor devices associated with vehicles 510a and 510c determine other navigation instructions. In yet another example, the secondary anchor device associated with vehicle 510c may detect that lane 3 is available, determine to move to lane 3, and transmit an indication of that determination to the secondary anchor devices associated with vehicles 510a and 510b, such that the secondary anchor devices associated with vehicles 510a and 510b determine other navigation instructions. In any of the aspects described above, the navigation instruction(s) may be further based at least in part on the requesting vehicle 605 being an emergency vehicle. For example, secondary anchor devices associated with vehicles 510a, 510b, and 510c may each determine a more aggressive navigation instruction (e.g., a faster deceleration, a faster lane change, and so on) based at least in part on the requesting vehicle 605 being an emergency vehicle.

Each secondary anchor device may transmit, and devices included in the respective sub-platoon may receive, the respective navigation instruction. As shown in FIG. 6, the navigation instruction may include application of brakes and/or movement into a lane that does not include additional sub platoons. Accordingly, in example 600, the secondary anchor device associated with vehicle 510a may instruct the vehicle 510a based at least in part on a determined navigation instruction as well as transmit the navigation instruction to the device associated with vehicle 515a, which may instruct the vehicle 515a based at least in part on the navigation instruction. Similarly, the secondary anchor device associated with vehicle 510b may instruct the vehicle 510b based at least in part on a determined navigation instruction as well as transmit the navigation instruction to the device associated with vehicle 515b, which may instruct the vehicle 515b based at least in part on the navigation instruction. Similarly, the secondary anchor device associated with vehicle 510c may instruct the vehicle 510c based at least in part on a determined navigation instruction as well as transmit the navigation instruction to the device associated with vehicle 515c, which may instruct the vehicle 515c based at least in part on the navigation instruction.

In some aspects, the platoon may reassemble (e.g., as described above in connection with FIG. 4) after the requesting vehicle 605 has completed the lane change. For example, the primary anchor device associated with vehicle 510a may transmit, and the secondary anchor devices associated with vehicles 510b and 510c may receive, an indication that the platoon is reassembling. Additionally, or alternatively, the primary anchor device associated with vehicle 510a may transmit, and a PCS may receive, an indication that the requesting device 605 has completed the lane change, such that the PCS may transmit, and the secondary anchor devices associated with vehicles 510b and 510c may receive, an indication that the platoon is reassembling based at least in part on the indication that all vehicles have proceeded past the emergency.

By using techniques as described in connection with FIG. 6, some sub-platoons may change lanes in response to a lane change request. As a result, the platoon does not trigger a shockwave effect, which wastes fuel and power. Additionally, the sub-platoons may reassemble the platoon after the lane change request is complete with much less network overhead as compared with each vehicle independently rejoining the platoon.

As indicated above, FIG. 6 is provided as an example. Other examples may differ from what is described with respect to FIG. 6.

FIG. 7 is a diagram illustrating an example 700 associated with sub-platooning within a V2X system, in accordance with the present disclosure. In example 700, mobile stations associated with vehicles 710a, 715a, 710b, and 715b may be included in a platoon. Additionally, the mobile station associated with vehicle 710a may serve as a primary anchor device for the platoon as well as a secondary anchor device for a sub-platoon that also includes the mobile station associated with vehicle 715a. Similarly, the mobile station associated with vehicle 710b may serve as a secondary anchor device for a sub-platoon that also includes the mobile station associated with vehicle 715b. The platoon and sub-platoons of example 700 may be formed as described above in connection with FIG. 4.

As shown in FIG. 7, the primary anchor device associated with vehicle 710a may detect an upcoming traffic signal using one or more sensors (e.g., an optical camera, an infrared camera, a LIDAR, a RADAR, and/or another sensor). For example, the primary anchor device associated with vehicle 710a may detect a traffic light and/or another traffic signal. Accordingly, the primary anchor device associated with vehicle 710a may transmit, and the secondary anchor device associated with vehicle 710b may receive, an indication of the upcoming traffic signal. Additionally, or alternatively, the primary anchor device associated with vehicle 710a may transmit, and a PCS may receive, the indication of the upcoming traffic signal, such that the PCS may transmit, and the secondary anchor device associated with vehicle 710b may receive, an indication that the platoon is dividing (e.g., as described above in connection with FIG. 4) based at least in part on the indication of the upcoming traffic signal.

Accordingly, the secondary anchor devices associated with vehicles 710a and 710b may determine respective navigation instructions, based at least in part on the indication of the upcoming traffic signal, that are different from each other. In example 700, the secondary anchor device associated with vehicle 710a has determined to proceed through the traffic signal, and the secondary anchor device associated with vehicle 710b has determined to stop at the traffic signal. For example, the secondary anchor device associated with vehicle 710a may determine that an amount of time before the traffic signal changes (e.g., indicated in a broadcast signal and/or detected using one or more sensors) is long enough such that the sub-platoon, associated with the secondary anchor device associated with vehicle 710a, can proceed through the traffic signal. On the other hand, the secondary anchor device associated with vehicle 710b may determine that the amount of time before the traffic signal changes is not long enough such that the sub-platoon, associated with the secondary anchor device associated with vehicle 710b, should stop at the traffic signal.

Each secondary anchor device may transmit, and devices included in the respective sub-platoon may receive, the respective navigation instruction. As shown in FIG. 7, the navigation instruction may include proceeding through the traffic signal or stopping at the traffic signal. Accordingly, in example 700, the secondary anchor device associated with vehicle 710a may instruct the vehicle 710a based at least in part on a determined navigation instruction as well as transmit the navigation instruction to the device associated with vehicle 715a, which may instruct the vehicle 715a based at least in part on the navigation instruction. Similarly, the secondary anchor device associated with vehicle 710b may instruct the vehicle 710b based at least in part on a determined navigation instruction as well as transmit the navigation instruction to the device associated with vehicle 715b, which may instruct the vehicle 715b based at least in part on the navigation instruction.

Although described above with respect to the traffic signal, the platoon may similarly divide based at least in part on traffic conditions. For example, the primary anchor device associated with vehicle 710a may detect an upcoming slow down, traffic jam, and/or other change in traffic conditions using one or more sensors (e.g., an optical camera, an infrared camera, a LIDAR, a RADAR, and/or another sensor). Accordingly, the primary anchor device associated with vehicle 710a may transmit, and the secondary anchor device associated with vehicle 710b may receive, an indication of the change in traffic conditions and/or an indication that the platoon is dividing (e.g., as described above in connection with FIG. 4) based at least in part on the indication of the change in traffic conditions. Additionally, or alternatively, the primary anchor device associated with vehicle 710a may transmit, and a PCS may receive, the indication of the change in traffic conditions, such that the PCS may transmit, and the secondary anchor device associated with vehicle 710b may receive, an indication of the change in traffic conditions and/or an indication that the platoon is dividing (e.g., as described above in connection with FIG. 4) based at least in part on the indication of the change in traffic conditions.

In some aspects, the platoon may reassemble (e.g., as described above in connection with FIG. 4) after all vehicles in the platoon have proceeded through the traffic signal. For example, the primary anchor device associated with vehicle 710a may transmit, and the secondary anchor device associated with vehicle 710b may receive, an indication that the platoon is reassembling. Additionally, or alternatively, the primary anchor device associated with vehicle 710a may transmit, and a PCS may receive, an indication that all vehicles have proceeded through the traffic signal, such that the PCS may transmit, and the secondary anchor device associated with vehicles 710b may receive, an indication that the platoon is reassembling based at least in part on the indication that all vehicles have proceeded through the traffic signal.

Although described above with respect to the traffic signal, the platoon may similarly reassemble based at least in part on traffic conditions. For example, the primary anchor device associated with vehicle 710a may detect an upcoming speed up, loosening of a traffic jam, and/or other change in traffic conditions using one or more sensors (e.g., an optical camera, an infrared camera, a LIDAR, a RADAR, and/or another sensor). Accordingly, the primary anchor device associated with vehicle 710a may transmit, and the secondary anchor device associated with vehicle 710b may receive, an indication of the change in traffic conditions and/or an indication that the platoon is reassemble (e.g., as described above in connection with FIG. 4) based at least in part on the indication of the change in traffic conditions. Additionally, or alternatively, the primary anchor device associated with vehicle 710a may transmit, and a PCS may receive, the indication of the change in traffic conditions, such that the PCS may transmit, and the secondary anchor device associated with vehicle 710b may receive, an indication of the change in traffic conditions and/or an indication that the platoon is reassembling (e.g., as described above in connection with FIG. 4) based at least in part on the indication of the change in traffic conditions.

By using techniques as described in connection with FIG. 7, some sub-platoons may proceed through the traffic signal while other sub-platoons stop at the traffic signal. As a result, the platoon does not waste fuel and power by stopping all vehicles in the platoon at the traffic signal. Additionally, the sub-platoons may reassemble the platoon after all vehicles have proceeded through the traffic signal with much less network overhead as compared with each vehicle independently rejoining the platoon.

As indicated above, FIG. 7 is provided as an example. Other examples may differ from what is described with respect to FIG. 7.

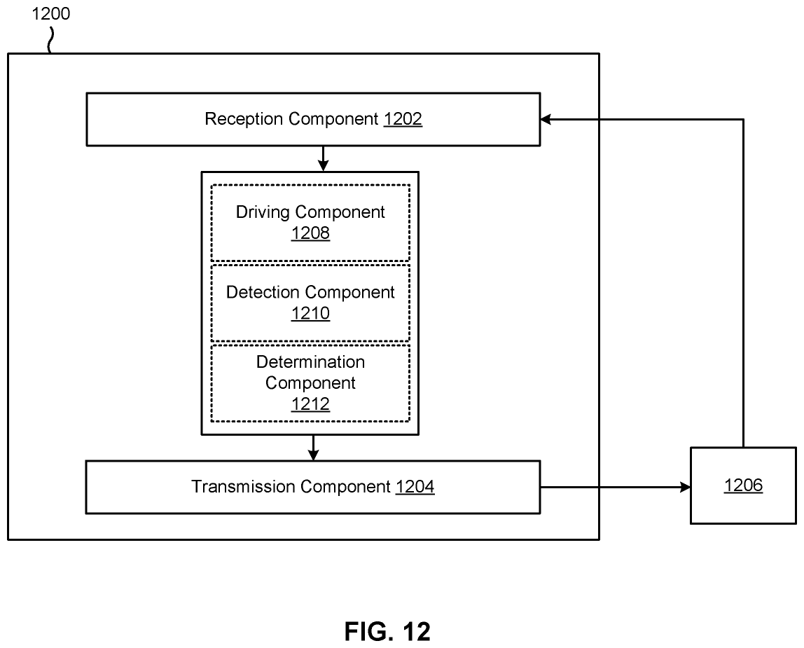

FIG. 8 is a diagram illustrating an example process 800 performed, for example, by a mobile station, in accordance with the present disclosure. Example process 800 is an example where the mobile station (e.g., UE 120 and/or apparatus 1200 of FIG. 12) performs operations associated with forming and managing sub-platoons within V2X technology.

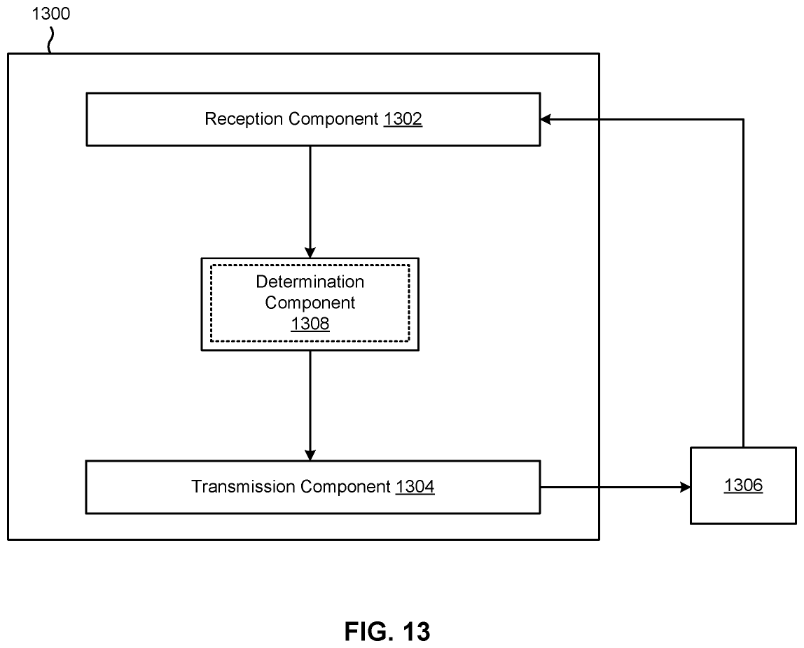

As shown in FIG. 8, in some aspects, process 800 may include transmitting, to a controller (e.g., base station 110 and/or apparatus 1300 of FIG. 13, or another UE and/or another apparatus 1200 of FIG. 12), a request to join a platoon (block 810). For example, the mobile station (e.g., using transmission component 1204, depicted in FIG. 12) may transmit the request to join a platoon, as described above.

As further shown in FIG. 8, in some aspects, process 800 may include receiving, from the controller, a confirmation that the mobile station has joined the platoon (block 820). For example, the mobile station (e.g., using reception component 1202, depicted in FIG. 12) may receive the confirmation that the mobile station has joined the platoon, as described above. In some aspects, the confirmation further indicates an assignment of the mobile station to a sub-platoon within the platoon.

As further shown in FIG. 8, in some aspects, process 800 may include transmitting a handshake to, or receiving a handshake from, a primary anchor device (e.g., another UE and/or another apparatus 1200 of FIG. 12) associated with the platoon (block 830). For example, the mobile station (e.g., using transmission component 1204 and/or reception component 1202) may transmit a handshake to, or receive a handshake from, a primary anchor device associated with the platoon, as described above.

As further shown in FIG. 8, in some aspects, process 800 may include transmitting a handshake to, or receiving a handshake from, a secondary anchor device (e.g., another UE and/or another apparatus 1200 of FIG. 12) associated with the sub-platoon (block 840). For example, the mobile station (e.g., using transmission component 1204 and/or reception component 1202) may transmit a handshake to, or receive a handshake from, a secondary anchor device associated with the sub-platoon, as described above.

Process 800 may include additional aspects, such as any single aspect or any combination of aspects described below and/or in connection with one or more other processes described elsewhere herein.

In a first aspect, the controller includes a PCS or the primary anchor device.

In a second aspect, alone or in combination with the first aspect, process 800 further includes transmitting (e.g., using transmission component 1204), to the controller, a request to leave the platoon, and receiving (e.g., using reception component 1202), from the controller, a confirmation that the mobile station is no longer in the platoon, the confirmation further indicating that the mobile station is no longer in the sub-platoon.

In a third aspect, alone or in combination with one or more of the first and second aspects, process 800 further includes receiving (e.g., using reception component 1202), from the secondary anchor device, a navigation instruction based at least in part on an emergency indication from the primary anchor device, the navigation instruction being coordinated with one or more additional sub-platoons within the platoon.

In a fourth aspect, alone or in combination with one or more of the first through third aspects, process 800 further includes instructing (e.g., using driving component 1208, depicted in FIG. 12) a vehicle including the mobile station based at least in part on the navigation instruction.

In a fifth aspect, alone or in combination with one or more of the first through fourth aspects, the navigation instruction includes application of brakes, movement into a lane that does not include the one or more additional sub-platoons, or a combination thereof.

In a sixth aspect, alone or in combination with one or more of the first through fifth aspects, process 800 further includes receiving (e.g., using reception component 1202), from the secondary anchor device, an indication that the platoon is dividing based at least in part on a maximum platoon size determined by the primary anchor device, and refraining from handshaking (e.g., using transmission component 1204 and/or reception component 1202) with the primary anchor device based at least in part on the indication that the platoon is dividing.

In a seventh aspect, alone or in combination with one or more of the first through sixth aspects, process 800 further includes receiving (e.g., using reception component 1202), from the secondary anchor device, an indication that the platoon is reassembling based at least in part on a revised maximum platoon size determined by the primary anchor device, and resuming handshaking (e.g., using transmission component 1204 and/or reception component 1202) with the primary anchor device based at least in part on the indication that the platoon is reassembling.

In an eighth aspect, alone or in combination with one or more of the first through seventh aspects, process 800 further includes receiving (e.g., using reception component 1202), from the secondary anchor device, a navigation instruction based at least in part on a lane change request received by the primary anchor device, the navigation instruction being coordinated with one or more additional sub-platoons within the platoon.

In a ninth aspect, alone or in combination with one or more of the first through eighth aspects, the navigation instruction is further based at least in part on a requesting vehicle being an emergency vehicle.

In a tenth aspect, alone or in combination with one or more of the first through ninth aspects, process 800 further includes receiving (e.g., using reception component 1202), from the secondary anchor device, an indication that the platoon is dividing based at least in part on an upcoming traffic signal detected by the primary anchor device, and receiving (e.g., using reception component 1202), from the secondary anchor device, a navigation instruction based at least in part on the upcoming traffic signal, the navigation instruction being different than an additional navigation instruction associated with an additional sub-platoon within the platoon.

In an eleventh aspect, alone or in combination with one or more of the first through tenth aspects, the navigation instruction includes proceeding through the traffic signal, or stopping at the traffic signal.

In a twelfth aspect, alone or in combination with one or more of the first through eleventh aspects, process 800 further includes refraining from handshaking (e.g., using transmission component 1204 and/or reception component 1202) with the primary anchor device based at least in part on the indication that the platoon is dividing.

In a thirteenth aspect, alone or in combination with one or more of the first through twelfth aspects, process 800 further includes receiving (e.g., using reception component 1202), from the secondary anchor device, an indication that the platoon is reassembling based at least in part on all sub-platoons within the platoon proceeding through the traffic signal, and resuming handshaking (e.g., using transmission component 1204 and/or reception component 1202) with the primary anchor device based at least in part on the indication that the platoon is reassembling.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a mobile station, in accordance with the present disclosure. Example process 900 is an example where the mobile station (e.g., UE 120 and/or apparatus 1200 of FIG. 12) performs operations associated with forming and managing sub-platoons within V2X technology.

As shown in FIG. 9, in some aspects, process 900 may include receiving, from a controller (e.g., base station 110 and/or apparatus 1300 of FIG. 13, or another UE and/or another apparatus 1200 of FIG. 12), an indication that the mobile station is a secondary anchor device for a sub-platoon within a platoon (block 910). For example, the mobile station (e.g., using reception component 1202, depicted in FIG. 12) may receive the indication that the mobile station is a secondary anchor device for a sub-platoon within a platoon, as described above. In some aspects, the platoon includes a primary anchor device and the mobile station.

As further shown in FIG. 9, in some aspects, process 900 may include transmitting a handshake to, or receiving a handshake from, the primary anchor device associated with the platoon (block 920). For example, the mobile station (e.g., using reception component 1202 and/or transmission component 1204, depicted in FIG. 12) may transmit a handshake to, or receive a handshake from, the primary anchor device associated with the platoon, as described above.

As further shown in FIG. 9, in some aspects, process 900 may include transmitting one or more handshakes to, or receiving one or more handshakes from, one or more additional mobile stations (e.g., one or more additional UEs and/or one or more additional apparatuses 1200 of FIG. 12) included in the sub-platoon (block 930). For example, the mobile station (e.g., using reception component 1202 and/or transmission component 1204) may transmit one or more handshakes to, or receive one or more handshakes from, one or more additional mobile stations included in the sub-platoon, as described above.

Process 900 may include additional aspects, such as any single aspect or any combination of aspects described below and/or in connection with one or more other processes described elsewhere herein.

In a first aspect, the controller includes a PCS or the primary anchor device.

In a second aspect, alone or in combination with the first aspect, process 900 further includes transmitting (e.g., using transmission component 1204), to the controller, a request to leave the platoon, and receiving (e.g., using reception component 1202), from the controller, a confirmation that the mobile station is no longer in the platoon, the confirmation further indicating that the mobile station is no longer the secondary anchor device for the sub-platoon.

In a third aspect, alone or in combination with one or more of the first and second aspects, process 900 further includes receiving (e.g., using reception component 1202), from the primary anchor device, an emergency indication, and transmitting (e.g., using transmission component 1204), to the one or more additional mobile stations included in the sub-platoon, a navigation instruction based at least in part on the emergency indication from the primary anchor device, the navigation instruction being coordinated with one or more additional sub-platoons within the platoon.

In a fourth aspect, alone or in combination with one or more of the first through third aspects, process 900 further includes instructing (e.g., using driving component 1208, depicted in FIG. 12) a vehicle including the mobile station based at least in part on the navigation instruction.

In a fifth aspect, alone or in combination with one or more of the first through fourth aspects, the navigation instruction includes application of brakes, moving into a lane that does not include the one or more additional sub-platoons, or a combination thereof.

In a sixth aspect, alone or in combination with one or more of the first through fifth aspects, process 900 further includes receiving (e.g., using reception component 1202), from the primary anchor device, an indication of a maximum platoon size, and transmitting (e.g., using transmission component 1204), to the one or more additional mobile stations included in the sub-platoon, an indication that the platoon is dividing based at least in part on the indication of the maximum platoon size received from the primary anchor device.

In a seventh aspect, alone or in combination with one or more of the first through sixth aspects, process 900 further includes refraining from handshaking (e.g., using transmission component 1204 and/or reception component 1202) with the primary anchor device based at least in part on the indication that the platoon is dividing.

In an eighth aspect, alone or in combination with one or more of the first through seventh aspects, process 900 further includes receiving (e.g., using reception component 1202), from the primary anchor device, an indication of a revised maximum platoon size, and transmitting (e.g., using transmission component 1204), to the one or more additional mobile stations included in the sub-platoon, an indication that the platoon is reassembling based at least in part on indication of revised maximum platoon size received from the primary anchor device.

In a ninth aspect, alone or in combination with one or more of the first through eighth aspects, process 900 further includes resuming handshaking (e.g., using transmission component 1204 and/or reception component 1202) with the primary anchor device based at least in part on the indication that the platoon is reassembling.

In a tenth aspect, alone or in combination with one or more of the first through ninth aspects, process 900 further includes receiving (e.g., using reception component 1202), from the primary anchor device, an indication of a lane change request, and transmitting (e.g., using transmission component 1204), to the one or more additional mobile stations included in the sub-platoon, a navigation instruction based at least in part on the indication of the lane change request, the navigation instruction being coordinated with one or more additional sub-platoons within the platoon.

In an eleventh aspect, alone or in combination with one or more of the first through tenth aspects, the navigation instruction is further based at least in part on a requesting vehicle being an emergency vehicle.

In a twelfth aspect, alone or in combination with one or more of the first through eleventh aspects, process 900 further includes receiving (e.g., using reception component 1202), from the primary anchor device, an indication of an upcoming traffic signal, transmitting (e.g., using transmission component 1204), to the one or more additional mobile stations included in the sub-platoon, an indication that the platoon is dividing based at least in part on the indication of the upcoming traffic signal, and transmitting (e.g., using transmission component 1204), to the one or more additional mobile stations included in the sub-platoon, a navigation instruction based at least in part on the upcoming traffic signal, the navigation instruction being different than an additional navigation instruction associated with an additional sub-platoon within the platoon.

In a thirteenth aspect, alone or in combination with one or more of the first through twelfth aspects, the navigation instruction includes proceeding through the traffic signal, or stopping at the traffic signal.

In a fourteenth aspect, alone or in combination with one or more of the first through thirteenth aspects, process 900 further includes transmitting (e.g., using transmission component 1204), to the one or more additional mobile stations included in the sub-platoon, an indication that the platoon is reassembling based at least in part on all sub-platoons within the platoon proceeding through the traffic signal, and resuming handshaking (e.g., using transmission component 1204 and/or reception component 1202) with the primary anchor device based at least in part on the indication that the platoon is reassembling.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a mobile station, in accordance with the present disclosure. Example process 1000 is an example where the mobile station (e.g., UE 120 and/or apparatus 1200 of FIG. 12) performs operations associated with forming and managing sub-platoons within V2X technology.

As shown in FIG. 10, in some aspects, process 1000 may include transmitting, to an additional mobile station (e.g., another UE and/or another apparatus 1200 of FIG. 12), an indication that the additional mobile station is a secondary anchor device for a sub-platoon within a platoon (block 1010). For example, the mobile station (e.g., using transmission component 1204, depicted in FIG. 12) may transmit the indication that the additional mobile station is a secondary anchor device for a sub-platoon within a platoon, as described above. In some aspects, the mobile station is a primary anchor device for the platoon.

As further shown in FIG. 10, in some aspects, process 1000 may include transmitting a handshake to, or receiving a handshake from, the secondary anchor device associated with the sub-platoon (block 1020). For example, the mobile station (e.g., using transmission component 1204 and/or reception component 1202, depicted in FIG. 12) may transmit a handshake to, or receiving a handshake from, the secondary anchor device associated with the sub-platoon, as described above.

As further shown in FIG. 10, in some aspects, process 1000 may include transmitting one or more handshakes to, or receiving one or more handshakes from, one or more other mobile stations (e.g., one or more other UEs and/or one or more other apparatuses 1200 of FIG. 12) included in the platoon (block 1030). For example, the mobile station (e.g., using transmission component 1204 and/or reception component 1202) may transmit one or more handshakes to, or receiving one or more handshakes from, one or more other mobile stations included in the platoon, as described above.

Process 1000 may include additional aspects, such as any single aspect or any combination of aspects described below and/or in connection with one or more other processes described elsewhere herein.

In a first aspect, process 1000 further includes receiving (e.g., using reception component 1202), from the additional mobile station, a request to leave the platoon, and transmitting (e.g., using transmission component 1204), to the additional mobile station, a confirmation that the additional mobile station is no longer in the platoon, the confirmation further indicating that the additional mobile station is no longer the secondary anchor device for the sub-platoon.

In a second aspect, alone or in combination with the first aspect, process 1000 further includes detecting (e.g., using detection component 1210, depicted in FIG. 12) an emergency using one or more sensors, and transmitting (e.g., using transmission component 1204), to the additional mobile station, an indication of the emergency, such that the additional mobile station determines a navigation instruction, based at least in part on the indication of the emergency, in coordination with one or more additional sub-platoons within the platoon.

In a third aspect, alone or in combination with one or more of the first and second aspects, process 1000 further includes determining (e.g., using determination component 1212, depicted in FIG. 12) a maximum platoon size, and transmitting (e.g., using transmission component 1204), to the additional mobile station, an indication of the maximum platoon size, the platoon being divided based at least in part on the indication of the maximum platoon size.

In a fourth aspect, alone or in combination with one or more of the first through third aspects, process 1000 further includes refraining from handshaking (e.g., using transmission component 1204 and/or reception component 1202) with the additional mobile station based at least in part on the platoon being divided.

In a fifth aspect, alone or in combination with one or more of the first through fourth aspects, process 1000 further includes determining (e.g., using determination component 1308) a revised maximum platoon size, and transmitting (e.g., using transmission component 1204), to the additional mobile station, an indication of the revised maximum platoon size, the platoon being reassembled based at least in part on the indication of the revised maximum platoon size.

In a sixth aspect, alone or in combination with one or more of the first through fifth aspects, process 1000 further includes resuming handshaking (e.g., using transmission component 1204 and/or reception component 1202) with the additional mobile station based at least in part on the platoon being reassembled.

In a seventh aspect, alone or in combination with one or more of the first through sixth aspects, process 1000 further includes receiving (e.g., using reception component 1202), from a requesting vehicle, a lane change request, and transmitting (e.g., using transmission component 1204), to the additional mobile station, an indication of the lane change request, such that the additional mobile station determines a navigation instruction, based at least in part on the indication of the lane change request, in coordination with one or more additional sub-platoons within the platoon.

In an eighth aspect, alone or in combination with one or more of the first through seventh aspects, the indication of the lane change request is further based at least in part on the requesting vehicle being an emergency vehicle.

In a ninth aspect, alone or in combination with one or more of the first through eighth aspects, process 1000 further includes detecting (e.g., using detection component 1210) an upcoming traffic signal, and transmitting (e.g., using transmission component 1204), to the additional mobile station, an indication of the upcoming traffic signal, the platoon being divided based at least in part on the upcoming traffic signal, and such that the additional mobile station determines a navigation instruction, based at least in part on the indication of the upcoming traffic signal, that is different than an additional navigation instruction associated with an additional sub-platoon within the platoon.

In a tenth aspect, alone or in combination with one or more of the first through ninth aspects, process 1000 further includes transmitting (e.g., using transmission component 1204), to the mobile station, an indication that all sub-platoons within the platoon have proceeded through the traffic signal, the platoon being reassembled based at least in part on the indication, and resuming handshaking (e.g., using transmission component 1204 and/or reception component 1202) with the additional mobile station based at least in part on the platoon being reassembled.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a control system, in accordance with the present disclosure. Example process 1100 is an example where the control system (e.g., base station 110 and/or apparatus 1300 of FIG. 13) performs operations associated with forming and managing sub-platoons within V2X technology.

As shown in FIG. 11, in some aspects, process 1100 may include receiving, from a mobile station (e.g., UE 120 and/or apparatus 1200 of FIG. 12), a request to join a platoon (block 1110). For example, the control system (e.g., using reception component 1302, depicted in FIG. 13) may receive the request to join a platoon, as described above.

As further shown in FIG. 11, in some aspects, process 1100 may include transmitting, to the mobile station, a confirmation that the mobile station has joined the platoon (block 1120). For example, the control system (e.g., using transmission component 1304, depicted in FIG. 13) may transmit the confirmation that the mobile station has joined the platoon, as described above. In some aspects, the confirmation further indicates an assignment of the mobile station to a sub-platoon within the platoon.

Process 1100 may include additional aspects, such as any single aspect or any combination of aspects described below and/or in connection with one or more other processes described elsewhere herein.

In a first aspect, process 1100 further includes transmitting (e.g., using transmission component 1304), to a primary anchor device (e.g., another UE and/or another apparatus 1200 of FIG. 12) of the platoon, an indication that the mobile station has joined the platoon, and transmitting (e.g., using transmission component 1304), to a secondary anchor device (e.g., another UE and/or another apparatus 1200 of FIG. 12) of the sub-platoon, an indication that the mobile station has joined the sub-platoon.

In a second aspect, alone or in combination with the first aspect, process 1100 further includes receiving (e.g., using reception component 1302), from the mobile station, a request to leave the platoon, and transmitting (e.g., using transmission component 1304), to the mobile station, a confirmation that the mobile station is no longer in the platoon, the confirmation further indicating that the mobile station is no longer in the sub-platoon.

In a third aspect, alone or in combination with one or more of the first and second aspects, process 1100 further includes transmitting (e.g., using transmission component 1304), to a primary anchor device of the platoon, an indication that the mobile station is no longer in the platoon, and transmitting (e.g., using transmission component 1304), to a secondary anchor device of the sub-platoon, an indication that the mobile station is no longer in the sub-platoon.

In a fourth aspect, alone or in combination with one or more of the first through third aspects, process 1100 further includes receiving (e.g., using reception component 1302), from a primary anchor device of the platoon, an emergency indication, and transmitting (e.g., using transmission component 1304), to a secondary anchor device of the sub-platoon, an indication that the platoon is dividing based at least in part on the indication of the emergency indication.

In a fifth aspect, alone or in combination with one or more of the first through fourth aspects, process 1100 further includes determining (e.g., using determination component 1308, depicted in FIG. 13) a maximum platoon size, and transmitting (e.g., using transmission component 1304), to a secondary anchor device of the sub-platoon, an indication that the platoon is dividing based at least in part on the maximum platoon size.

In a sixth aspect, alone or in combination with one or more of the first through fifth aspects, process 1100 further includes determining (e.g., using determination component 1308) a revised maximum platoon size, and transmitting (e.g., using transmission component 1304), to a secondary anchor device of the sub-platoon, an indication that the platoon is reassembling based at least in part on the revised maximum platoon size.

In a seventh aspect, alone or in combination with one or more of the first through sixth aspects, process 1100 further includes receiving (e.g., using reception component 1302), from a primary anchor device of the platoon, an indication of a lane change request, and transmitting (e.g., using transmission component 1304), to a secondary anchor device of the sub-platoon, an indication that the platoon is dividing based at least in part on the indication of the lane change request.

In an eighth aspect, alone or in combination with one or more of the first through seventh aspects, the indication that the platoon is dividing is further based at least in part on a requesting vehicle, associated with the lane change request, being an emergency vehicle.

In a ninth aspect, alone or in combination with one or more of the first through eighth aspects, process 1100 further includes receiving (e.g., using reception component 1302), from a primary anchor device of the platoon, an indication of an upcoming traffic signal, and transmitting (e.g., using transmission component 1304), to a secondary anchor device of the sub-platoon, an indication that the platoon is dividing based at least in part on the indication of the upcoming traffic signal.

In a tenth aspect, alone or in combination with one or more of the first through ninth aspects, process 1100 further includes receiving (e.g., using reception component 1302), from a primary anchor device of the platoon, an indication that all sub-platoons within the platoon have proceeded through the traffic signal, and transmitting (e.g., using transmission component 1304), to a secondary anchor device of the sub-platoon, an indication that the platoon is reassembling based at least in part on the indication that all sub-platoons within the platoon proceeded through the traffic signal.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a block diagram of an example apparatus 1200 for wireless communication. The apparatus 1200 may be mobile station (e.g., a UE), or a mobile station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include one or more of a driving component 1208, a detection component 1210, or a determination component 1212, among other examples.

In some aspects, the apparatus 1200 may be configured to perform one or more operations described herein in connection with FIGS. 4-7. Additionally, or alternatively, the apparatus 1200 may be configured to perform one or more processes described herein, such as process 800 of FIG. 8, process 900 of FIG. 9, process 1000 of FIG. 10, or a combination thereof. In some aspects, the apparatus 1200 and/or one or more components shown in FIG. 12 may include one or more components of the UE described above in connection with FIG. 2. Additionally, or alternatively, one or more components shown in FIG. 12 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1206. In some aspects, the reception component 1202 may include one or more antennas, a demodulator, a MIMO detector, a receive processor, a controller/processor, a memory, or a combination thereof, of the UE described above in connection with FIG. 2.

The transmission component 1204 may transmit communications, such as reference signals, control information, data communications, or a combination thereof, to the apparatus 1206. In some aspects, one or more other components of the apparatus 1206 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modulator, a transmit MIMO processor, a transmit processor, a controller/processor, a memory, or a combination thereof, of the UE described above in connection with FIG. 2. In some aspects, the transmission component 1204 may be co-located with the reception component 1202 in a transceiver.

In some aspects, the transmission component 1204 may transmit (e.g., to the apparatus 1206) a request to join a platoon. Accordingly, the reception component 1202 may receive (e.g., from the apparatus 1206) a confirmation that the apparatus 1200 has joined the platoon. The confirmation may further indicate an assignment of the apparatus 1200 to a sub-platoon within the platoon. The transmission component 1204 may transmit a handshake to, and/or the reception component 1202 may receive a handshake from, a primary anchor device associated with the platoon. Additionally, the transmission component 1204 may transmit a handshake to, and/or the reception component 1202 may receive a handshake from, a secondary anchor device associated with the sub-platoon.

In some aspects, the transmission component 1204 may transmit (e.g., to the apparatus 1206) a request to leave the platoon. Accordingly, the reception component 1202 may receive (e.g., from the apparatus 1206) a confirmation that the apparatus 1200 is no longer in the platoon. The confirmation may further indicate that the apparatus 1200 is no longer in the sub-platoon.

In some aspects, the reception component 1202 may receive, from the secondary anchor device, a navigation instruction based at least in part on an emergency indication from the primary anchor device. The navigation instruction may be coordinated with one or more additional sub-platoons within the platoon. Accordingly, the driving component 1208 may instruct a vehicle including the apparatus 1200 based at least in part on the navigation instruction. In some aspects, the driving component 1208 may include a controller/processor, a memory, or a combination thereof, of the UE described above in connection with FIG. 2.

Additionally, or alternatively, the reception component 1202 may receive, from the secondary anchor device, an indication that the platoon is dividing based at least in part on a maximum platoon size determined by the primary anchor device. Accordingly, the reception component 1202 and/or the transmission component 1204 may refrain from handshaking with the primary anchor device based at least in part on the indication that the platoon is dividing. In some aspects, the reception component 1202 may further receive, from the secondary anchor device, an indication that the platoon is reassembling based at least in part on a revised maximum platoon size determined by the primary anchor device. Accordingly, the reception component 1202 and/or the transmission component 1204 may resume handshaking with the primary anchor device based at least in part on the indication that the platoon is reassembling.

Additionally, or alternatively, the reception component 1202 may receive, from the secondary anchor device, a navigation instruction based at least in part on a lane change request received by the primary anchor device. The navigation instruction may be coordinated with one or more additional sub-platoons within the platoon. Accordingly, the driving component 1208 may instruct a vehicle including the apparatus 1200 based at least in part on the navigation instruction.

Additionally, or alternatively, the reception component 1202 may receive, from the secondary anchor device, an indication that the platoon is dividing based at least in part on an upcoming traffic signal detected by the primary anchor device. Accordingly, the reception component 1202 and/or the transmission component 1204 may refrain from handshaking with the primary anchor device based at least in part on the indication that the platoon is dividing. In some aspects, the reception component 1202 may further receive, from the secondary anchor device, a navigation instruction based at least in part on the upcoming traffic signal. The navigation instruction may be different than an additional navigation instruction associated with an additional sub-platoon within the platoon. Accordingly, the driving component 1208 may instruct a vehicle including the apparatus 1200 based at least in part on the navigation instruction. In some aspects, the reception component 1202 may further receive, from the secondary anchor device, an indication that the platoon is reassembling based at least in part on all sub-platoons within the platoon proceeding through the traffic signal. Accordingly, the reception component 1202 and/or the transmission component 1204 may resume handshaking with the primary anchor device based at least in part on the indication that the platoon is reassembling.

In some aspects, the apparatus 1200 may serve as a secondary anchor device. For example, the reception component 1202 may receive (e.g., from the apparatus 1206) an indication that the apparatus 1200 is a secondary anchor device for a sub-platoon within a platoon. The platoon may include a primary anchor device and the apparatus 1200. Accordingly, the transmission component 1204 may transmit a handshake to, and/or the reception component 1202 may receive a handshake from, the primary anchor device associated with the platoon. Additionally, the transmission component 1204 may transmit one or more handshakes to, and/or the reception component 1202 may receive one or more handshakes from, one or more additional mobile stations included in the sub-platoon.

In some aspects, the transmission component 1204 may transmit (e.g., to the apparatus 1206) a request to leave the platoon. Accordingly, the reception component 1202 may receive (e.g., from the apparatus 1206) a confirmation that the apparatus 1200 is no longer in the platoon. The confirmation may further indicate that the apparatus 1200 is no longer the secondary anchor device for the sub-platoon.

In some aspects, the reception component 1202 may receive, from the primary anchor device, an emergency indication. Accordingly, the transmission component 1204 may transmit, to the one or more additional mobile stations included in the sub-platoon, a navigation instruction based at least in part on the emergency indication from the primary anchor device. The navigation instruction may be coordinated with one or more additional sub-platoons within the platoon. Additionally, the driving component 1208 may instruct a vehicle including the apparatus 1200 based at least in part on the navigation instruction.

Additionally, or alternatively, the reception component 1202 may receive, from the primary anchor device, an indication of a maximum platoon size. Accordingly, the transmission component 1204 may transmit, to the one or more additional mobile stations included in the sub-platoon, an indication that the platoon is dividing based at least in part on the indication of the maximum platoon size received from the primary anchor device. Additionally, the transmission component 1204 and/or the reception component 1202 may refrain from handshaking with the primary anchor device based at least in part on the indication that the platoon is dividing. In some aspects, the reception component 1202 may further receive, from the primary anchor device, an indication of a revised maximum platoon size. Accordingly, the transmission component 1204 may transmit, to the one or more additional mobile stations included in the sub-platoon, an indication that the platoon is reassembling based at least in part on indication of revised maximum platoon size received from the primary anchor device. Additionally, the transmission component 1204 and/or the reception component 1202 may resume handshaking with the primary anchor device based at least in part on the indication that the platoon is reassembling.

Additionally, or alternatively, the reception component 1202 may receive, from the primary anchor device, an indication of a lane change request. Accordingly, the transmission component 1204 may transmit, to the one or more additional mobile stations included in the sub-platoon, a navigation instruction based at least in part on the indication of the lane change request. The navigation instruction may be coordinated with one or more additional sub-platoons within the platoon. Additionally, the driving component 1208 may instruct a vehicle including the apparatus 1200 based at least in part on the navigation instruction.

Additionally, or alternatively, the reception component 1202 may receive, from the primary anchor device, an indication of an upcoming traffic signal. Accordingly, the transmission component 1204 may transmit, to the one or more additional mobile stations included in the sub-platoon, an indication that the platoon is dividing based at least in part on the indication of the upcoming traffic signal. Accordingly, the transmission component 1204 and/or the reception component 1202 may refrain from handshaking with the primary anchor device based at least in part on the indication that the platoon is dividing. In some aspects, the transmission component 1204 may further transmit, to the one or more additional mobile stations included in the sub-platoon, a navigation instruction based at least in part on the upcoming traffic signal. The navigation instruction may be different than an additional navigation instruction associated with an additional sub-platoon within the platoon. Additionally, the driving component 1208 may instruct a vehicle including the apparatus 1200 based at least in part on the navigation instruction. In some aspects, the transmission component 1204 may further transmit, to the one or more additional mobile stations included in the sub-platoon, an indication that the platoon is reassembling based at least in part on all sub-platoons within the platoon proceeding through the traffic signal. Additionally, the transmission component 1204 and/or the reception component 1202 may resume handshaking with the primary anchor device based at least in part on the indication that the platoon is reassembling.

In some aspects, the apparatus 1200 may serve as a primary anchor device. For example, the transmission component 1204 may transmit, to an additional mobile station, an indication that the additional mobile station is a secondary anchor device for a sub-platoon within a platoon. Accordingly, the transmission component 1204 may transmit a handshake to, and/or the reception component 1202 may receive a handshake from, the secondary anchor device associated with the sub-platoon. Additionally, the transmission component 1204 may transmit one or more handshakes to, and/or the reception component 1202 may receive one or more handshakes from, one or more other mobile stations included in the platoon.

In some aspects, the reception component 1202 may receive, from the additional mobile station, a request to leave the platoon. Accordingly, the transmission component 1204 may transmit, to the additional mobile station, a confirmation that the additional mobile station is no longer in the platoon. The confirmation may further indicate that the additional mobile station is no longer the secondary anchor device for the sub-platoon.

In some aspects, the detection component 1210 may detect an emergency using one or more sensors. In some aspects, the detection component 1210 may include a controller/processor, a memory, or a combination thereof, of the UE described above in connection with FIG. 2. Accordingly, the transmission component 1204 may transmit, to the additional mobile station, an indication of the emergency. The additional mobile station may determine a navigation instruction, based at least in part on the indication of the emergency, in coordination with one or more additional sub-platoons within the platoon.

Additionally, or alternatively, the determination component 1212 may determine a maximum platoon size. In some aspects, the determination component 1212 may include a controller/processor, a memory, or a combination thereof, of the UE described above in connection with FIG. 2. Accordingly, the transmission component 1204 may transmit, to the additional mobile station, an indication of the maximum platoon size. The platoon may be divided based at least in part on the indication of the maximum platoon size. Accordingly, the transmission component 1204 and/or the reception component 1202 may refrain from handshaking with the additional mobile station based at least in part on the platoon being divided. In some aspects, the determination component 1212 may further determine a revised maximum platoon size. Accordingly, the transmission component 1204 may transmit, to the additional mobile station, an indication of the revised maximum platoon size. The platoon may be reassembled based at least in part on the indication of the revised maximum platoon size. Accordingly, the transmission component 1204 and/or the reception component 1202 may resume handshaking with the additional mobile station based at least in part on the platoon being reassembled.

Additionally, or alternatively, the reception component 1202 may receive, from a requesting vehicle, a lane change request. Accordingly, the transmission component 1204 may transmit, to the additional mobile station, an indication of the lane change request. The additional mobile station may determine a navigation instruction, based at least in part on the indication of the lane change request, in coordination with one or more additional sub-platoons within the platoon.

Additionally, or alternatively, the detection component 1210 may detect an upcoming traffic signal. Accordingly, the transmission component 1204 may transmit, to the additional mobile station, an indication of the upcoming traffic signal. The platoon may be divided based at least in part on the upcoming traffic signal, and the additional mobile station may determine a navigation instruction, based at least in part on the indication of the upcoming traffic signal, that is different than an additional navigation instruction associated with an additional sub-platoon within the platoon. Accordingly, the transmission component 1204 and/or the reception component 1202 may refrain from handshaking with the additional mobile station based at least in part on the platoon being divided. In some aspects, the transmission component 1204 may further transmit, to the mobile station, an indication that all sub-platoons within the platoon have proceeded through the traffic signal. The platoon may be reassembled based at least in part on the indication. Accordingly, the transmission component 1204 and/or the reception component 1202 may resume handshaking with the additional mobile station based at least in part on the platoon being reassembled.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a block diagram of an example apparatus 1300 for wireless communication. The apparatus 1300 may be a control system (e.g., a base station and/or a PCS), or a control system may include the apparatus 1300. In some aspects, the apparatus 1300 includes a reception component 1302 and a transmission component 1304, which may be in communication with one another (for example, via one or more buses and/or one or more other components). As shown, the apparatus 1300 may communicate with another apparatus 1306 (such as a UE, a base station, or another wireless communication device) using the reception component 1302 and the transmission component 1304. As further shown, the apparatus 1300 may include a determination component 1308, among other examples.

In some aspects, the apparatus 1300 may be configured to perform one or more operations described herein in connection with FIGS. 4-7. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the base station described above in connection with FIG. 2. Additionally, or alternatively, one or more components shown in FIG. 13 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1306. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1306. In some aspects, the reception component 1302 may include one or more antennas, a demodulator, a MIMO detector, a receive processor, a controller/processor, a memory, or a combination thereof, of the base station described above in connection with FIG. 2.

The transmission component 1304 may transmit communications, such as reference signals, control information, data communications, or a combination thereof, to the apparatus 1306. In some aspects, one or more other components of the apparatus 1306 may generate communications and may provide the generated communications to the transmission component 1304 for transmission to the apparatus 1306. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1306. In some aspects, the transmission component 1304 may include one or more antennas, a modulator, a transmit MIMO processor, a transmit processor, a controller/processor, a memory, or a combination thereof, of the base station described above in connection with FIG. 2. In some aspects, the transmission component 1304 may be co-located with the reception component 1302 in a transceiver.

In some aspects, the reception component 1302 may receive (e.g., from the apparatus 1306) a request to join a platoon. Accordingly, the transmission component 1304 may transmit (e.g., to the apparatus 1306) a confirmation that the apparatus 1306 has joined the platoon. The confirmation may further indicate an assignment of the apparatus 1306 to a sub-platoon within the platoon.

In some aspects, the transmission component 1304 may further transmit, to a primary anchor device of the platoon, an indication that the apparatus 1306 has joined the platoon and/or transmit, to a secondary anchor device of the sub-platoon, an indication that the apparatus 1306 has joined the sub-platoon.

In some aspects, the reception component 1302 may receive (e.g., from the apparatus 1306) a request to leave the platoon. Accordingly, the transmission component 1304 may transmit (e.g., to the apparatus 1306) a confirmation that the apparatus 1306 is no longer in the platoon. The confirmation may further indicate that the apparatus 1306 is no longer in the sub-platoon.

In some aspects, the transmission component 1304 may further transmit, to the primary anchor device of the platoon, an indication that the apparatus 1306 is no longer in the platoon and/or transmit, to the secondary anchor device of the sub-platoon, an indication that the apparatus 1306 is no longer in the sub-platoon.

In some aspects, the reception component 1302 may receive, from the primary anchor device of the platoon, an emergency indication. Accordingly, the transmission component 1304 may transmit, to the secondary anchor device of the sub-platoon, an indication that the platoon is dividing based at least in part on the indication of the emergency indication.

Additionally, or alternatively, the determination component 1308 may determine a maximum platoon size. In some aspects, the determination component 1308 may include a controller/processor, a memory, or a combination thereof, of the base station described above in connection with FIG. 2. Accordingly, the transmission component 1304 may transmit, to the secondary anchor device of the sub-platoon, an indication that the platoon is dividing based at least in part on the maximum platoon size. In some aspects, the determination component 1308 may further determine a revised maximum platoon size. Accordingly, the transmission component 1304 may transmit, to the secondary anchor device of the sub-platoon, an indication that the platoon is reassembling based at least in part on the revised maximum platoon size.

Additionally, or alternatively, the reception component 1302 may receive, from the primary anchor device of the platoon, an indication of a lane change request. Accordingly, the transmission component 1304 may transmit, to the secondary anchor device of the sub-platoon, an indication that the platoon is dividing based at least in part on the indication of the lane change request.

Additionally, or alternatively, the reception component 1302 may receive, from the primary anchor device of the platoon, an indication of an upcoming traffic signal. Accordingly, the transmission component 1304 may transmit, to the secondary anchor device of the sub-platoon, an indication that the platoon is dividing based at least in part on the indication of the upcoming traffic signal. In some aspects, the reception component 1302 may receive, from the primary anchor device of the platoon, an indication that all sub-platoons within the platoon have proceeded through the traffic signal. Accordingly, the transmission component 1304 may transmit, to the secondary anchor device of the sub-platoon, an indication that the platoon is reassembling based at least in part on the indication that all sub-platoons within the platoon proceeded through the traffic signal.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a mobile station, comprising: transmitting, to a controller, a request to join a platoon; receiving, from the controller, a confirmation that the mobile station has joined the platoon, wherein the confirmation further indicates an assignment of the mobile station to a sub-platoon within the platoon; transmitting a handshake to, or receiving a handshake from, a primary anchor device associated with the platoon; and transmitting a handshake to, or receiving a handshake from, a secondary anchor device associated with the sub-platoon.

Aspect 2: The method of Aspect 1, wherein the controller includes a platooning control system or the primary anchor device.

Aspect 3: The method of any of Aspects 1 through 2, further comprising: transmitting, to the controller, a request to leave the platoon; and receiving, from the controller, a confirmation that the mobile station is no longer in the platoon, wherein the confirmation further indicates that the mobile station is no longer in the sub-platoon.

Aspect 4: The method of any of Aspects 1 through 3, further comprising: receiving, from the secondary anchor device, a navigation instruction based at least in part on an emergency indication from the primary anchor device, wherein the navigation instruction is coordinated with one or more additional sub-platoons within the platoon.

Aspect 5: The method of Aspect 4, further comprising: instructing a vehicle including the mobile station based at least in part on the navigation instruction.

Aspect 6: The method of any of Aspects 4 through 5, wherein the navigation instruction comprises: application of brakes; movement into a lane that does not include the one or more additional sub-platoons; or a combination thereof.

Aspect 7: The method of any of Aspects 1 through 6, further comprising: receiving, from the secondary anchor device, an indication that the platoon is dividing based at least in part on a maximum platoon size determined by the primary anchor device; and refraining from handshaking with the primary anchor device based at least in part on the indication that the platoon is dividing.

Aspect 8: The method of Aspect 7, further comprising: receiving, from the secondary anchor device, an indication that the platoon is reassembling based at least in part on a revised maximum platoon size determined by the primary anchor device; and resuming handshaking with the primary anchor device based at least in part on the indication that the platoon is reassembling.

Aspect 9: The method of any of Aspects 1 through 8, further comprising: receiving, from the secondary anchor device, a navigation instruction based at least in part on a lane change request received by the primary anchor device, wherein the navigation instruction is coordinated with one or more additional sub-platoons within the platoon.

Aspect 10: The method of Aspect 9, wherein the navigation instruction is further based at least in part on a requesting vehicle being an emergency vehicle.

Aspect 11: The method of any of Aspects 9 through 10, further comprising: instructing a vehicle including the mobile station based at least in part on the navigation instruction.

Aspect 12: The method of any of Aspects 9 through 11, wherein the navigation instruction comprises: application of brakes; movement into a lane that does not include the one or more additional sub-platoons; or a combination thereof.

Aspect 13: The method of any of Aspects 1 through 12, further comprising: receiving, from the secondary anchor device, an indication that the platoon is dividing based at least in part on an upcoming traffic signal detected by the primary anchor device; and receiving, from the secondary anchor device, a navigation instruction based at least in part on the upcoming traffic signal, wherein the navigation instruction is different than an additional navigation instruction associated with an additional sub-platoon within the platoon.

Aspect 14: The method of Aspect 13, further comprising: instructing a vehicle including the mobile station based at least in part on the navigation instruction.

Aspect 15: The method of any of Aspects 13 through 14, wherein the navigation instruction comprises: proceeding through the traffic signal; or stopping at the traffic signal.

Aspect 16: The method of any of Aspects 13 through 15, further comprising: refraining from handshaking with the primary anchor device based at least in part on the indication that the platoon is dividing.

Aspect 17: The method of any of Aspects 13 through 16, further comprising: receiving, from the secondary anchor device, an indication that the platoon is reassembling based at least in part on all sub-platoons within the platoon proceeding through the traffic signal; and resuming handshaking with the primary anchor device based at least in part on the indication that the platoon is reassembling.

Aspect 18: A method of wireless communication performed by a mobile station, comprising: receiving, from a controller, an indication that the mobile station is a secondary anchor device for a sub-platoon within a platoon, wherein the platoon includes a primary anchor device and the mobile station; transmitting a handshake to, or receiving a handshake from, the primary anchor device associated with the platoon; and transmitting one or more handshakes to, or receiving one or more handshakes from, one or more additional mobile stations included in the sub-platoon.

Aspect 19: The method of Aspect 18, wherein the controller includes a platooning control system or the primary anchor device.

Aspect 20: The method of any of Aspects 18 through 19, further comprising: transmitting, to the controller, a request to leave the platoon; and receiving, from the controller, a confirmation that the mobile station is no longer in the platoon, wherein the confirmation further indicates that the mobile station is no longer the secondary anchor device for the sub-platoon.

Aspect 21: The method of any of Aspects 18 through 20, further comprising: receiving, from the primary anchor device, an emergency indication; and transmitting, to the one or more additional mobile stations included in the sub-platoon, a navigation instruction based at least in part on the emergency indication from the primary anchor device, wherein the navigation instruction is coordinated with one or more additional sub-platoons within the platoon.

Aspect 22: The method of Aspect 21, further comprising: instructing a vehicle including the mobile station based at least in part on the navigation instruction.

Aspect 23: The method of any of Aspects 21 through 22, wherein the navigation instruction comprises: application of brakes; moving into a lane that does not include the one or more additional sub-platoons; or a combination thereof.

Aspect 24: The method of any of Aspects 18 through 23, further comprising: receiving, from the primary anchor device, an indication of a maximum platoon size; and transmitting, to the one or more additional mobile stations included in the sub-platoon, an indication that the platoon is dividing based at least in part on the indication of the maximum platoon size received from the primary anchor device.

Aspect 25: The method of Aspect 24, further comprising: refraining from handshaking with the primary anchor device based at least in part on the indication that the platoon is dividing.

Aspect 26: The method of any of Aspects 24 through 25, further comprising: receiving, from the primary anchor device, an indication of a revised maximum platoon size; and transmitting, to the one or more additional mobile stations included in the sub-platoon, an indication that the platoon is reassembling based at least in part on indication of revised maximum platoon size received from the primary anchor device.

Aspect 27: The method of Aspect 26, further comprising: resuming handshaking with the primary anchor device based at least in part on the indication that the platoon is reassembling.

Aspect 28: The method of any of Aspects 18 through 27, further comprising: receiving, from the primary anchor device, an indication of a lane change request; and transmitting, to the one or more additional mobile stations included in the sub-platoon, a navigation instruction based at least in part on the indication of the lane change request, wherein the navigation instruction is coordinated with one or more additional sub-platoons within the platoon.

Aspect 29: The method of Aspect 28, wherein the navigation instruction is further based at least in part on a requesting vehicle being an emergency vehicle.

Aspect 30: The method of any of Aspects 28 through 29, further comprising: instructing a vehicle including the mobile station based at least in part on the navigation instruction.

Aspect 31: The method of any of Aspects 28 through 30, wherein the navigation instruction comprises: application of brakes; movement into a lane that does not include the one or more additional sub-platoons; or a combination thereof.

Aspect 32: The method of any of Aspects 18 through 31, further comprising: receiving, from the primary anchor device, an indication of an upcoming traffic signal; transmitting, to the one or more additional mobile stations included in the sub-platoon, an indication that the platoon is dividing based at least in part on the indication of the upcoming traffic signal; and transmitting, to the one or more additional mobile stations included in the sub-platoon, a navigation instruction based at least in part on the upcoming traffic signal, wherein the navigation instruction is different than an additional navigation instruction associated with an additional sub-platoon within the platoon.

Aspect 33: The method of Aspect 32, further comprising: instructing a vehicle including the mobile station based at least in part on the navigation instruction.

Aspect 34: The method of any of Aspects 32 through 33, wherein the navigation instruction comprises: proceeding through the traffic signal; or stopping at the traffic signal.

Aspect 35: The method of any of Aspects 32 through 34, further comprising: refraining from handshaking with the primary anchor device based at least in part on the indication that the platoon is dividing.

Aspect 36: The method of any of Aspects 32 through 35, further comprising: transmitting, to the one or more additional mobile stations included in the sub-platoon, an indication that the platoon is reassembling based at least in part on all sub-platoons within the platoon proceeding through the traffic signal; and resuming handshaking with the primary anchor device based at least in part on the indication that the platoon is reassembling.

Aspect 37: A method of wireless communication performed by a mobile station, comprising: transmitting, to an additional mobile station, an indication that the additional mobile station is a secondary anchor device for a sub-platoon within a platoon, wherein the mobile station is a primary anchor device for the platoon; transmitting a handshake to, or receiving a handshake from, the secondary anchor device associated with the sub-platoon; and transmitting one or more handshakes to, or receiving one or more handshakes from, one or more other mobile stations included in the platoon.

Aspect 38: The method of Aspect 37, further comprising: receiving, from the additional mobile station, a request to leave the platoon; and transmitting, to the additional mobile station, a confirmation that the additional mobile station is no longer in the platoon, wherein the confirmation further indicates that the additional mobile station is no longer the secondary anchor device for the sub-platoon.

Aspect 39: The method of any of Aspects 37 through 38, further comprising: detecting an emergency using one or more sensors; and transmitting, to the additional mobile station, an indication of the emergency, wherein the additional mobile station determines a navigation instruction, based at least in part on the indication of the emergency, in coordination with one or more additional sub-platoons within the platoon.

Aspect 40: The method of any of Aspects 37 through 39, further comprising: determining a maximum platoon size; and transmitting, to the additional mobile station, an indication of the maximum platoon size, wherein the platoon is divided based at least in part on the indication of the maximum platoon size.

Aspect 41: The method of Aspect 40, further comprising: refraining from handshaking with the additional mobile station based at least in part on the platoon being divided.

Aspect 42: The method of any of Aspects 40 through 41, further comprising: determining a revised maximum platoon size; and transmitting, to the additional mobile station, an indication of the revised maximum platoon size, wherein the platoon is reassembled based at least in part on the indication of the revised maximum platoon size.

Aspect 43: The method of Aspect 42, further comprising: resuming handshaking with the additional mobile station based at least in part on the platoon being reassembled.

Aspect 44: The method of any of Aspects 37 through 43, further comprising: receiving, from a requesting vehicle, a lane change request; and transmitting, to the additional mobile station, an indication of the lane change request, wherein the additional mobile station determines a navigation instruction, based at least in part on the indication of the lane change request, in coordination with one or more additional sub-platoons within the platoon.

Aspect 45: The method of Aspect 44, wherein the indication of the lane change request is further based at least in part on the requesting vehicle being an emergency vehicle.

Aspect 46: The method of any of Aspects 37 through 45, further comprising: detecting an upcoming traffic signal; and transmitting, to the additional mobile station, an indication of the upcoming traffic signal, wherein the platoon is divided based at least in part on the upcoming traffic signal, and wherein the additional mobile station determines a navigation instruction, based at least in part on the indication of the upcoming traffic signal, that is different than an additional navigation instruction associated with an additional sub-platoon within the platoon.

Aspect 47: The method of Aspect 46, further comprising: refraining from handshaking with the additional mobile station based at least in part on the platoon being divided.

Aspect 48: The method of any of Aspects 46 through 47, further comprising: transmitting, to the mobile station, an indication that all sub-platoons within the platoon have proceeded through the traffic signal, wherein the platoon is reassembled based at least in part on the indication; and resuming handshaking with the additional mobile station based at least in part on the platoon being reassembled.

Aspect 49: A method of wireless communication performed by a control system, comprising: receiving, from a mobile station, a request to join a platoon; and transmitting, to the mobile station, a confirmation that the mobile station has joined the platoon, wherein the confirmation further indicates an assignment of the mobile station to a sub-platoon within the platoon.

Aspect 50: The method of Aspect 49, further comprising: transmitting, to a primary anchor device of the platoon, an indication that the mobile station has joined the platoon; and transmitting, to a secondary anchor device of the sub-platoon, an indication that the mobile station has joined the sub-platoon.

Aspect 51: The method of any of Aspects 49 through 50, further comprising: receiving, from the mobile station, a request to leave the platoon; and transmitting, to the mobile station, a confirmation that the additional mobile station is no longer in the platoon, wherein the confirmation further indicates that the mobile station is no longer in the sub-platoon.

Aspect 52: The method of Aspect 51, further comprising: transmitting, to a primary anchor device of the platoon, an indication that the mobile station is no longer in the platoon; and transmitting, to a secondary anchor device of the sub-platoon, an indication that the mobile station is no longer in the sub-platoon.

Aspect 53: The method of any of Aspects 49 through 52, further comprising: receiving, from a primary anchor device of the platoon, an emergency indication; and transmitting, to a secondary anchor device of the sub-platoon, an indication that the platoon is dividing based at least in part on the indication of the emergency indication.

Aspect 54: The method of any of Aspects 49 through 53, further comprising: determining a maximum platoon size; and transmitting, to a secondary anchor device of the sub-platoon, an indication that the platoon is dividing based at least in part on the maximum platoon size.

Aspect 55: The method of Aspect 54, further comprising: determining a revised maximum platoon size; and transmitting, to a secondary anchor device of the sub-platoon, an indication that the platoon is reassembling based at least in part on the revised maximum platoon size.

Aspect 56: The method of any of Aspects 49 through 55, further comprising: receiving, from a primary anchor device of the platoon, an indication of a lane change request; and transmitting, to a secondary anchor device of the sub-platoon, an indication that the platoon is dividing based at least in part on the indication of the lane change request.

Aspect 57: The method of Aspect 56, wherein the indication that the platoon is dividing is further based at least in part on a requesting vehicle, associated with the lane change request, being an emergency vehicle.

Aspect 58: The method of any of Aspects 49 through 57, further comprising: receiving, from a primary anchor device of the platoon, an indication of an upcoming traffic signal; and transmitting, to a secondary anchor device of the sub-platoon, an indication that the platoon is dividing based at least in part on the indication of the upcoming traffic signal.

Aspect 59: The method of Aspect 58, further comprising: receiving, from a primary anchor device of the platoon, an indication that all sub-platoons within the platoon have proceeded through the traffic signal; and transmitting, to a secondary anchor device of the sub-platoon, an indication that the platoon is reassembling based at least in part on the indication that all sub-platoons within the platoon proceeded through the traffic signal.

Aspect 60: An apparatus for wireless communication at a device, comprising a processor; memory coupled with the processor; and instructions stored in the memory and executable by the processor to cause the apparatus to perform the method of one or more Aspects of Aspects 1-17.

Aspect 61: A device for wireless communication, comprising a memory and one or more processors coupled to the memory, the memory and the one or more processors configured to perform the method of one or more Aspects of Aspects 1-17.

Aspect 62: An apparatus for wireless communication, comprising at least one means for performing the method of one or more Aspects of Aspects 1-17.

Aspect 63: A non-transitory computer-readable medium storing code for wireless communication, the code comprising instructions executable by a processor to perform the method of one or more Aspects of Aspects 1-17.

Aspect 64: A non-transitory computer-readable medium storing a set of instructions for wireless communication, the set of instructions comprising one or more instructions that, when executed by one or more processors of a device, cause the device to perform the method of one or more Aspects of Aspects 1-17.

Aspect 65: An apparatus for wireless communication at a device, comprising a processor; memory coupled with the processor; and instructions stored in the memory and executable by the processor to cause the apparatus to perform the method of one or more Aspects of Aspects 18-36.

Aspect 66: A device for wireless communication, comprising a memory and one or more processors coupled to the memory, the memory and the one or more processors configured to perform the method of one or more Aspects of Aspects 18-36.

Aspect 67: An apparatus for wireless communication, comprising at least one means for performing the method of one or more Aspects of Aspects 18-36.

Aspect 68: A non-transitory computer-readable medium storing code for wireless communication, the code comprising instructions executable by a processor to perform the method of one or more Aspects of Aspects 18-36.

Aspect 69: A non-transitory computer-readable medium storing a set of instructions for wireless communication, the set of instructions comprising one or more instructions that, when executed by one or more processors of a device, cause the device to perform the method of one or more Aspects of Aspects 18-36.

Aspect 70: An apparatus for wireless communication at a device, comprising a processor; memory coupled with the processor; and instructions stored in the memory and executable by the processor to cause the apparatus to perform the method of one or more Aspects of Aspects 37-48.

Aspect 71: A device for wireless communication, comprising a memory and one or more processors coupled to the memory, the memory and the one or more processors configured to perform the method of one or more Aspects of Aspects 37-48.

Aspect 72: An apparatus for wireless communication, comprising at least one means for performing the method of one or more Aspects of Aspects 37-48.

Aspect 73: A non-transitory computer-readable medium storing code for wireless communication, the code comprising instructions executable by a processor to perform the method of one or more Aspects of Aspects 37-48.

Aspect 74: A non-transitory computer-readable medium storing a set of instructions for wireless communication, the set of instructions comprising one or more instructions that, when executed by one or more processors of a device, cause the device to perform the method of one or more Aspects of Aspects 37-48.

Aspect 75: An apparatus for wireless communication at a device, comprising a processor; memory coupled with the processor; and instructions stored in the memory and executable by the processor to cause the apparatus to perform the method of one or more Aspects of Aspects 49-59.

Aspect 76: A device for wireless communication, comprising a memory and one or more processors coupled to the memory, the memory and the one or more processors configured to perform the method of one or more Aspects of Aspects 49-59.

Aspect 77: An apparatus for wireless communication, comprising at least one means for performing the method of one or more Aspects of Aspects 49-59.

Aspect 78: A non-transitory computer-readable medium storing code for wireless communication, the code comprising instructions executable by a processor to perform the method of one or more Aspects of Aspects 49-59.

Aspect 79: A non-transitory computer-readable medium storing a set of instructions for wireless communication, the set of instructions comprising one or more instructions that, when executed by one or more processors of a device, cause the device to perform the method of one or more Aspects of Aspects 49-59.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a processor is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A mobile station, comprising:
a memory; and
one or more processors coupled to the memory, the memory and the one or more processors configured to:
transmit, to a controller, a request to join a platoon;
receive, from the controller, a confirmation that the mobile station has joined the platoon, wherein the confirmation further indicates an assignment of the mobile station to a sub-platoon within the platoon;
transmit a handshake to, or receive a handshake from, a primary anchor device associated with the platoon; and
transmit a handshake to, or receive a handshake from, a secondary anchor device associated with the sub-platoon.

2. The mobile station of claim 1, wherein the memory and the one or more processors are further configured to:
transmit, to the controller, a request to leave the platoon; and
receive, from the controller, a confirmation that the mobile station is no longer in the platoon, wherein the confirmation further indicates that the mobile station is no longer in the sub-platoon.

3. The mobile station of claim 1, wherein the memory and the one or more processors are further configured to:
receive, from the secondary anchor device, a navigation instruction based at least in part on an emergency indication from the primary anchor device, wherein the navigation instruction is coordinated with one or more additional sub-platoons within the platoon.

4. The mobile station of claim 1, wherein the memory and the one or more processors are further configured to:
receive, from the secondary anchor device, an indication that the platoon is dividing based at least in part on a maximum platoon size determined by the primary anchor device; and
refrain from handshaking with the primary anchor device based at least in part on the indication that the platoon is dividing.

5. The mobile station of claim 4, wherein the memory and the one or more processors are further configured to:
receive, from the secondary anchor device, an indication that the platoon is reassembling based at least in part on a revised maximum platoon size determined by the primary anchor device; and
resume handshaking with the primary anchor device based at least in part on the indication that the platoon is reassembling.

6. The mobile station of claim 1, wherein the memory and the one or more processors are further configured to:
receive, from the secondary anchor device, a navigation instruction based at least in part on a lane change request received by the primary anchor device, wherein the navigation instruction is coordinated with one or more additional sub-platoons within the platoon.

7. The mobile station of claim 1, wherein the memory and the one or more processors are further configured to:
receive, from the secondary anchor device, an indication that the platoon is dividing based at least in part on an upcoming traffic signal detected by the primary anchor device; and
receive, from the secondary anchor device, a navigation instruction based at least in part on the upcoming traffic signal, wherein the navigation instruction is different than an additional navigation instruction associated with an additional sub-platoon within the platoon.

8. The mobile station of claim 7, wherein the memory and the one or more processors are further configured to:
refrain from handshaking with the primary anchor device based at least in part on the indication that the platoon is dividing.

9. The mobile station of claim 8, wherein the memory and the one or more processors are further configured to:
receive, from the secondary anchor device, an indication that the platoon is reassembling based at least in part on all sub-platoons within the platoon proceeding through the traffic signal; and
resume handshaking with the primary anchor device based at least in part on the indication that the platoon is reassembling.

10. A mobile station, comprising:
a memory; and
one or more processors coupled to the memory, the memory and the one or more processors configured to:
receive, from a controller, an indication that the mobile station is a secondary anchor device for a sub-platoon within a platoon, wherein the platoon includes a primary anchor device and the mobile station;
transmit a handshake to, or receive a handshake from, the primary anchor device associated with the platoon; and
transmit one or more handshakes to, or receive one or more handshakes from, one or more additional mobile stations included in the sub-platoon.

11. The mobile station of claim 10, wherein the memory and the one or more processors are further configured to:
transmit, to the controller, a request to leave the platoon; and
receive, from the controller, a confirmation that the mobile station is no longer in the platoon, wherein the confirmation further indicates that the mobile station is no longer the secondary anchor device for the sub-platoon.

12. The mobile station of claim 10, wherein the memory and the one or more processors are further configured to:
receive, from the primary anchor device, an emergency indication; and
transmit, to the one or more additional mobile stations included in the sub-platoon, a navigation instruction based at least in part on the emergency indication from the primary anchor device, wherein the navigation instruction is coordinated with one or more additional sub-platoons within the platoon.

13. The mobile station of claim 10, wherein the memory and the one or more processors are further configured to:
receive, from the primary anchor device, an indication of a maximum platoon size; and
transmit, to the one or more additional mobile stations included in the sub-platoon, an indication that the platoon is dividing based at least in part on the indication of the maximum platoon size received from the primary anchor device.

14. The mobile station of claim 13, wherein the memory and the one or more processors are further configured to:
refrain from handshaking with the primary anchor device based at least in part on the indication that the platoon is dividing.

15. The mobile station of claim 14, wherein the memory and the one or more processors are further configured to:
receive, from the primary anchor device, an indication of a revised maximum platoon size; and
transmit, to the one or more additional mobile stations included in the sub-platoon, an indication that the platoon is reassembling based at least in part on indication of revised maximum platoon size received from the primary anchor device.

16. The mobile station of claim 10, wherein the memory and the one or more processors are further configured to:
receive, from the primary anchor device, an indication of a lane change request; and
transmit, to the one or more additional mobile stations included in the sub-platoon, a navigation instruction based at least in part on the indication of the lane change request, wherein the navigation instruction is coordinated with one or more additional sub-platoons within the platoon.

17. The mobile station of claim 10, wherein the memory and the one or more processors are further configured to:
receive, from the primary anchor device, an indication of an upcoming traffic signal;
transmit, to the one or more additional mobile stations included in the sub-platoon, an indication that the platoon is dividing based at least in part on the indication of the upcoming traffic signal; and
transmit, to the one or more additional mobile stations included in the sub-platoon, a navigation instruction based at least in part on the upcoming traffic signal, wherein the navigation instruction is different than an additional navigation instruction associated with an additional sub-platoon within the platoon.

18. The mobile station of claim 17, wherein the memory and the one or more processors are further configured to:
refrain from handshaking with the primary anchor device based at least in part on the indication that the platoon is dividing.

19. The mobile station of claim 18, wherein the memory and the one or more processors are further configured to:
transmit, to the one or more additional mobile stations included in the sub-platoon, an indication that the platoon is reassembling based at least in part on all sub-platoons within the platoon proceeding through the traffic signal; and
resume handshaking with the primary anchor device based at least in part on the indication that the platoon is reassembling.

20. A mobile station, comprising:
a memory; and
one or more processors coupled to the memory, the memory and the one or more processors configured to:
transmit, to an additional mobile station, an indication that the additional mobile station is a secondary anchor device for a sub-platoon within a platoon, wherein the mobile station is a primary anchor device for the platoon;
transmit a handshake to, or receive a handshake from, the secondary anchor device associated with the sub-platoon; and
transmit one or more handshakes to, or receive one or more handshakes from, one or more other mobile stations included in the platoon.

21. The mobile station of claim 20, wherein the memory and the one or more processors are further configured to:
receive, from the additional mobile station, a request to leave the platoon; and
transmit, to the additional mobile station, a confirmation that the additional mobile station is no longer in the platoon, wherein the confirmation further indicates that the additional mobile station is no longer the secondary anchor device for the sub-platoon.

22. The mobile station of claim 20, wherein the memory and the one or more processors are further configured to:
detect an emergency using one or more sensors; and
transmit, to the additional mobile station, an indication of the emergency, wherein the additional mobile station determines a navigation instruction, based at least in part on the indication of the emergency, in coordination with one or more additional sub-platoons within the platoon.

23. The mobile station of claim 20, wherein the memory and the one or more processors are further configured to:
determine a maximum platoon size; and
transmit, to the additional mobile station, an indication of the maximum platoon size, wherein the platoon is divided based at least in part on the indication of the maximum platoon size.

24. The mobile station of claim 23, wherein the memory and the one or more processors are further configured to:
refrain from handshaking with the additional mobile station based at least in part on the platoon being divided.

25. The mobile station of claim 24, wherein the memory and the one or more processors are further configured to:
determine a revised maximum platoon size; and
transmit, to the additional mobile station, an indication of the revised maximum platoon size, wherein the platoon is reassembled based at least in part on the indication of the revised maximum platoon size.

26. The mobile station of claim 20, wherein the memory and the one or more processors are further configured to:
receive, from a requesting vehicle, a lane change request; and
transmit, to the additional mobile station, an indication of the lane change request, wherein the additional mobile station determines a navigation instruction, based at least in part on the indication of the lane change request, in coordination with one or more additional sub-platoons within the platoon.

27. The mobile station of claim 20, wherein the memory and the one or more processors are further configured to:
detect an upcoming traffic signal; and
transmit, to the additional mobile station, an indication of the upcoming traffic signal, wherein the platoon is divided based at least in part on the upcoming traffic signal, and wherein the additional mobile station determines a navigation instruction, based at least in part on the indication of the upcoming traffic signal, that is different than an additional navigation instruction associated with an additional sub-platoon within the platoon.

28. The mobile station of claim 27, wherein the memory and the one or more processors are further configured to:
refrain from handshaking with the additional mobile station based at least in part on the platoon being divided.

29. The mobile station of claim 28, wherein the memory and the one or more processors are further configured to:
transmit, to the mobile station, an indication that all sub-platoons within the platoon have proceeded through the traffic signal, wherein the platoon is reassembled based at least in part on the indication; and
resume handshaking with the additional mobile station based at least in part on the platoon being reassembled.

30. A control system, comprising:
a memory; and
one or more processors coupled to the memory, the memory and the one or more processors configured to:
receive, from a mobile station, a request to join a platoon; and
transmit, to the mobile station, a confirmation that the mobile station has joined the platoon, wherein the confirmation further indicates an assignment of the mobile station to a sub-platoon within the platoon.
